(19) United States
(12) Patent Application Publication
(10) Pub. No.: US 2024/0406811 A1
(43) Pub. Date: Dec. 5, 2024

(54) INTER-CELL MOBILITY TRIGGERED BY THE NETWORK

(71) Applicant: ZTE Corporation, Shenzhen (CN)

(72) Inventors: Mengjie ZHANG, Shenzhen (CN); He HUANG, Shenzhen (CN); Jing LIU, Shenzhen (CN); Fei DONG, Shenzhen (CN)

(21) Appl. No.: 18/778,783

(22) Filed: Jul. 19, 2024

Related U.S. Application Data
(63) Continuation of application No. PCT/CN2022/073110, filed on Jan. 21, 2022.

(51) Int. Cl. H04W 36/00; H04W 36/04; H04W 56/00; H04W 76/20; H04W 80/02

(52) U.S. Cl. CPC H04W 36/0058; H04W 36/00835; H04W 36/04; H04W 56/0045; H04W 76/20; H04W 80/02

(57) ABSTRACT

In wireless communication, a device may change, add, or handover between cells of network access for inter-cell mobility. This may include Layer 1 and/or Layer 2 (L1/L2) signaling for a user equipment (UE) moving between cells in a network. The signaling can reduce the mobility interruption time and improve robustness of a handover. The movement may be triggered by the network or the UE. A Layer 1 and/or Layer 3 (L1/L3) measurement is used for the inter-cell mobility. The mobility may be coordinated based on interactions between a centralized unit (CU) and a distributed unit (DU). The procedures can reduce interruption time and improve reliability.

### CROSS REFERENCE TO RELATED APPLICATIONS

This application is a continuation of International Patent Application No. PCT/CN2022/073110, filed on Jan. 21, 2022, the disclosure of which is incorporated herein by reference in its entirety.

### TECHNICAL FIELD

This document is directed generally to wireless communications. More specifically, in a mobile device communications system, there may be improved signaling for inter-cell mobility.

### BACKGROUND

Wireless communication technologies are moving the world toward an increasingly connected and networked society. Wireless communications rely on efficient network resource management and allocation between user mobile stations and wireless access network nodes (including but not limited to wireless base stations). A new generation network is expected to provide high speed, low latency and ultra-reliable communication capabilities and fulfil the requirements from different industries and users. User mobile stations or user equipment (UE) are becoming more complex and the amount of data communicated continually increases. In order to improve communications and meet reliability requirements for the vertical industry as well as support the new generation network service, communication improvements should be made.

### SUMMARY

This document relates to methods, systems, and devices for Layer 1 and/or Layer 2 (L1/L2) signaling for a user equipment (UE) moving between cells in a network. The signaling can reduce the mobility interruption time and improve robustness of a handover. The movement may be triggered by the network or the UE. A Layer 1 and/or Layer 3 (L1/L3) measurement is used for the inter-cell mobility. The mobility may be coordinated based on interactions between a centralized unit (CU) and a distributed unit (DU).

In one embodiment, a wireless communications method includes receiving a configuration message that includes a plurality of candidate cells with configurations and cell identification (“ID”) information for each; sending a measurement report that comprises at least one of a Layer 1 (“L1”) measurement or a Layer 3 (“L3”) measurement for at least one of the candidate cells; receiving a command identifying at least one of the candidate cells based on the measurement report; and sending a communication to the identified at least one candidate cell based on the command and the configuration of the identified candidate cell.

The sending the measurement report and the communication is from a user equipment (“UE”) to a basestation, wherein the UE receives the configuration message and the command from the basestation. The command is a Layer 1 or Layer 2 (“L1/L2”) signaling and the communication sent to the identified candidate cell is L1/L2 signaling, wherein the L1 signaling comprises at least one of a downlink control information (“DCI”), a uplink control information (“UCI”), a physical layer acknowledge (“ACK”) signaling, further wherein the L2 signaling comprises a medium access control element (“MAC CE”). The command comprises cell ID information of the identified candidate cell, which is the cell to be activated. The cell ID information comprises at least one of a candidate cell configuration index, a serving cell ID, a physical cell identity (“PCI”), a PCI and frequency, a reference signal (“RS”) ID related to the candidate cell, or a transmission configuration indicator (“TCI”) state ID related to the candidate cell. The candidate cells comprise separate lists for any of the candidate cells that are configured as special cells (“SpCells”), or any of the candidate cells that are configured as secondary cells (“SCells”), wherein the identifying is based on the separate lists. The candidate cells comprise a list wherein each of the candidate cells can be configured as a special cell (“SpCell”) or secondary cell (“SCell”). The candidate cells comprise a list wherein each of the cells can be configured as a candidate cell for both a special cell (“SpCell”) and a secondary cell (“SCell”). The measurement report is triggered from the UE based on a condition, wherein the condition comprises at least one of an event met based on Layer 1 measurements of at least one candidate cell, an out of sync indication from a serving cell or a special cells (“SpCells”), or a failure of a serving cell or the SpCell. The command comprises at least one of a timing advance (“TA”) value or a compensatory TA value of the identified candidate cell, a cell Radio Network Temporary Identifier (“C-RNTI”) of the identified candidate cell, an activation DL/UL bandwidth part (“BWP”) ID of the identified candidate cell, an initial TCI state of the identified candidate cell, a serving cell ID of the identified candidate cell, an indication to indicate whether RACH procedure towards the identified candidate cell is skipped, an indication to indicate whether the UE maintains the connection with the current serving cell; an indication to indicate whether the identified candidate cell is activated as a special cell (“SpCell”); an indication to indicate whether PDCP duplication is activated after accessing the identified candidate cell.

The method further includes: activating a stored cell configuration of the identified candidate cell; applying a stored cell configuration of the identified candidate cell; or performing a mobility from the current serving cell to the identified candidate cell. The method further includes starting a timer for the activating or the mobility, wherein the timer is a media access control (“MAC”) layer timer or a radio resource control (“RRC”) layer timer. The timer is stopped based on a condition, wherein the condition comprises at least one of successful transmission of a communication to the identified candidate cell, a failure of a current serving cell, or information from an upper layer to indicate stopping of the timer. The method further includes determining a failure for the activating or the mobility, based on expiration of the timer. The method further includes reporting a failure for the activating or the mobility, to the basestation, wherein the failure is reported via a MAC CE or a RRC signaling; informing an upper layer about the failure for the activating or the mobility; or selecting another cell among the candidate cells to perform another activating of the selected another cell or perform another of the mobility to the selected another cell. The method further includes activating the identified candidate cell, wherein when the identified candidate cell is activated as a primary cell (“PCell”), a serving cell identification is set to zero; wherein when the identified candidate cell is activated as a secondary cell (“SCell”) or a primary secondary cell (“PSCell”), the serving cell identification is set based on a received identification for the identified candidate cell. The method further includes: receiving a message, from the basestation; and removing the stored candidate cell configuration, based on reception of the message. The method further includes: receiving a message, from the basestation, wherein the message comprises at least one of an indicator to remove all stored candidate cell configurations, or to remove some of the candidate cells; and removing the stored candidate cell configuration based on the indicator or the indicated candidate cells to be removed. The message is at least one of a handover command, primary secondary cell (“PSCell”) addition or/change command, or a message to command the release of a radio resource control (“RRC”) connection or the suspension of the RRC connection. The method further includes receiving a message, from the basestation, to resume the suspended radio resource control (“RRC”) connection; wherein the message comprises one or a plurality of candidate cell to be resumed, activated, maintained, or restored. The candidate cell refers to a candidate cell group, wherein the candidate cell group is at least one of a candidate master cell group (“MCG), or a candidate secondary cell group (“SCG”).

In another embodiment, a wireless communications method includes: sending a configuration message that includes a plurality of candidate cells with configurations and cell identification (ID) information for each; receiving a measurement report that comprises at least one of a Layer 1 (“L1”) measurement or a Layer 3 (“L3”) measurement for at least one of the candidate cells; sending a command identifying at least one of the candidate cells based on the measurement report; and receiving a communication at the identified at least one candidate cell, based on the command and the configuration of the identified candidate cell. The sending the configuration message and the command is from a basestation to a user equipment (“UE”), wherein the basestation receives the measurement report and the communication from the UE. The command is a Layer 1 or Layer 2 (“L1/L2”) signaling and the received communication at the identified candidate cell is a L1/L2 signaling, wherein the L1 signaling comprises at least one of a downlink control information (“DCI”), a uplink control information (“UCI”), a physical layer acknowledge (“ACK”) signaling, wherein the L2 signaling comprises a medium access control element (“MAC CE”). The command comprises cell ID information of the identified candidate cell, which is a cell to be activated. The cell ID information comprises at least one of a candidate cell configuration index, a serving cell ID, a physical cell identity (“PCI”), a PCI and frequency, a reference signal (“RS”) ID related to the candidate cell, or a transmission configuration indicator (“TCI”) state ID related to the candidate cell. The candidate cells comprise separate lists for any of the candidate cells that are configured as special cells (“SpCells”), or any of the candidate cells that are configured as secondary cells (“SCells”), wherein the identifying is based on the separate lists. The candidate cells comprise a list wherein each of the cells can be configured as a special cell (“SpCell”) or a secondary cell (“SCell”). The candidate cells comprise a list wherein each of the cells can be configured as a candidate cell for both a special cell (“SpCell”) and a secondary cell (“SCell”). The command comprises at least one of a timing advance (“TA”) value or compensatory TA value of the identified candidate cell, a cell Radio Network Temporary Identifier (“C-RNTI”) of the identified candidate cell, an activation DL/UL bandwidth part (“BWP”) ID of the identified candidate cell, an initial TCI state of the identified candidate cell, a serving cell ID of the identified candidate cell, an indication to indicate whether RACH procedure towards the identified candidate cell is skipped, an indication to indicate whether the UE maintains the connection with the current serving cell; an indication to indicate whether the identified candidate cell is activated as SpCell; an indication to indicate whether PDCP duplication is activated after accessing the identified candidate cell.

The method further includes sending a message, to the UE, wherein the message comprises at least one of an indicator to remove all stored candidate cell configuration, or a plurality of candidate cell to be removed; wherein the UE removes the stored candidate cell configuration based on the indicator or the indicated plurality of candidate cell to be removed. The message is at least one of a handover command, primary secondary cell (“PSCell”) addition or/change command, or a message to command the release of an radio resource control (“RRC”) connection or the suspension of the RRC connection. The method further includes sending a message, to the UE, to resume the suspended RRC connection, wherein the message comprises at least one of candidate cell to be resumed, activated, maintained, or restored. The candidate cell refers to a candidate cell group, wherein the candidate cell group is at least one of a candidate master cell group (“MCG) or a candidate secondary cell group (“SCG”).

In another embodiment, a wireless communications method includes: receiving a configuration message that includes a plurality of candidate cells with configurations, cell identification (“ID”) information, and one or more execution conditions; evaluating the execution conditions for the candidate cells to identify at least one of candidate cells; and sending a communication to the identified at least one candidate cell, based on the configuration of that candidate cell. The sending the communication is from a user equipment (“UE”) to a basestation, wherein the UE receives the configuration message from the basestation and the UE evaluates the execution conditions. The communication to the identified at least one candidate cell is a Layer 1 or Layer 2 (“L1/L2”) signaling, wherein the L1 signaling comprises at least one of a downlink control information (“DCI”), a uplink control information (“UCI”), a physical layer acknowledge (“ACK”) signaling, wherein the L2 signaling comprises a medium access control element (“MAC CE”). The evaluating comprises comparing the measurement results of candidate cells with execution conditions, wherein the identified at least one candidate cell satisfies the execution conditions. The execution conditions comprises at least one of a list of measurement configuration identifier information to indicate the execution condition, a measurement event based on the L1 measurement for the candidate cell, or a measurement event based on the L3 measurement for the candidate cell. The configuration message comprises at least one of an information to indicate a plurality of candidate cells can be identified together, or at least one execution condition for a plurality of candidate cells to be identified together. The communication comprises the cell ID information of the identified at least one candidate cell, or the information to indicate which of the candidate cells have been identified together. The cell ID information comprises at least one of a candidate cell configuration index, a serving cell ID, a physical cell identity (“PCI”), a PCI and frequency, a reference signal (“RS”) ID related to the candidate cell, or a transmission configuration indicator (“TCI”) state ID related to the candidate cell. The sending a communication to the identified at least one candidate cell is based on a condition that comprises at least one of an out of sync indication from a serving cell or a special cell (“SpCell”), or a failure of a serving cell or the SpCell. The candidate cells comprise separate lists for any of the candidate cells that are configured as special cells (“SpCells”) and any of the candidate cells that are configured as secondary cells (“SCells”), wherein the identifying is based on the separate lists. The candidate cells comprise a list wherein each of the candidate cells can be configured as a special cell (“SpCell”) or a secondary cell (“SCell”). The candidate cells comprise a list wherein each of the candidate cells can be configured as a candidate cell for both a special cell (“SpCell”) and a secondary cell (“SCell”).

The method further includes: activating a stored cell configuration of the identified at least one candidate cell; applying a stored cell configuration of the identified at least one candidate cell; or performing a mobility from the current serving cell to the identified at least one candidate cell. The method further includes: starting a timer for the activating or the mobility, wherein the timer is a media access control (“MAC”) layer timer or a radio resource control (“RRC”) layer timer. The timer is stopped based on a condition that comprises at least one of successful transmission of a communication to the identified at least one candidate cell, failures of a current serving cell, or an information from an upper layer to indicate a stopping of the timer. The method further includes determining a failure for the activating or the mobility, based on the expiration of the timer. The method further includes: reporting a failure for the activating or the mobility, to the basestation, wherein the failure is reported via a MAC CE or a RRC signaling; informing the upper layer about the failure for the activating or the mobility; or selecting another cell among the stored candidate cells to perform another activating of the selected another cell or perform another of the mobility to the selected another cell. The method further includes activating the identified at least one candidate cell, wherein when the identified at least one candidate cell is activated as a primary cell (“PCell”), a serving cell identification is set to zero and when the identified at least one candidate cell is activated as a secondary cell (“SCell”) or a primary secondary cell (“PSCell”), the serving cell identification is set based on a received identification for the identified at least one candidate cell. The method further includes: receiving a message, from the basestation; and removing the stored candidate cell configuration, based on reception of the message. The method further includes: receiving a message, from the basestation, wherein the message comprises at least one of an indicator to remove all stored candidate cell configuration, or a plurality of candidate cell to be removed; and removing the stored candidate cell configuration based on the indicator or the indicated candidate cells to be removed. The message is at least one of a handover command, primary secondary cell (“PSCell”) addition or/change command, or a message to command the release of an radio resource control (“RRC”) connection or the suspension of the RRC connection. The method further includes receiving a message, from the basestation, to resume the suspended RRC connection; wherein the message comprises at least one candidate cell to be resumed, activated, maintained, or restored. The candidate cell comprises a candidate cell group that is at least one of a candidate master cell group (“MCG), or a candidate secondary cell group (“SCG”).

In another embodiment, a wireless communications method includes: sending a configuration message that includes a plurality of candidate cells with configurations, cell identification (“ID”) information, and one or more execution conditions; and receiving a communication at an identified one of the candidate cells that is identified based on an evaluation of the candidate cells and their configurations. The sending the configuration message is from a basestation to a user equipment (“UE”), wherein the communication is received at the identified candidate cell of the basestation from the UE. The communication is a Layer 1 or Layer 2 (“L1/L2”) signaling, wherein the L1 signaling comprises at least one of a downlink control information (“DCI”), a uplink control information (“UCI”), a physical layer acknowledge (“ACK”) signaling, wherein the L2 signaling comprises a medium access control element (“MAC CE”). The receiving the communication at the identified candidate cell is based on a condition that comprises at least one of the identified candidate cell satisfying the triggering conditions, events triggered from out of sync indications from a serving cell or a special cell (“SpCell”), or failures of a serving cell or the SpCell. The execution conditions comprises at least one of a list of measurement configuration identifier information to indicate the execution condition, a measurement event based on the L1 measurement for the candidate cell, or a measurement event based on the L3 measurement for the candidate cell. The configuration message comprises at least one of an information to indicate a plurality of candidate cells can be identified together, or an execution condition for a plurality of candidate cells to be identified together. The communication comprises the cell ID information of the identified candidate cell, or the information to indicate that a plurality of the candidate cells have been identified together. The cell ID information comprises at least one of a candidate cell configuration index, a serving cell ID, a physical cell identity (“PCI”), a PCI and frequency, a reference signal (“RS”) ID related to the candidate cell, or a transmission configuration indicator (“TCI”) state ID related to the candidate cell. The candidate cells comprise separate lists for any of the candidate cells that are configured as special cells (“SpCells”), or any of the candidate cells that are configured as secondary cells (“SCells”), wherein the identifying is based on the separate lists. The candidate cells comprises a list wherein each of the cells can be configured as a candidate special cell (“SpCell”) or a candidate secondary cell (“SCell”). The candidate cells comprise a list wherein each of the candidate cells can be configured as a candidate cell for both a special cell (“SpCell”) and a secondary cell (“SCell”).

The method further includes sending a message, to the UE, wherein the message comprises at least one of an indicator to remove all stored candidate cell configuration, or a list of the candidate cells to be removed; wherein the UE removes the stored candidate cell configuration based on the indicator or the indicated list of candidate cells to be removed. The message is at least one of a handover command, primary secondary cell (“PSCell”) addition or/change command, or a message to command the release of an RRC connection or the suspension of the RRC connection. The method further includes sending a message, to the UE, to resume the suspended RRC connection; wherein the message comprises one or a list of the candidate cells to be resumed, activated, maintained, or restored. The candidate cell refers to a candidate cell group, wherein the candidate cell group is at least one of a candidate master cell group (“MCG), or a candidate secondary cell group (“SCG”).

In another embodiment, a wireless communications method includes: sending a request message that includes a plurality of candidate cells from a centralized unit (“CU”) to a distributed unit (“DU”), to request the DU to configure at least one of the candidate cells for a Layer 1 or Layer 2 (“L1/L2”) signaling based mobility (“L1/L2 mobility”); and receiving, at the CU from the DU, a response message that includes a list of candidate cells and configurations for each of the candidate cells, wherein the candidate cell list is used for identifying at least one of the candidate cells that has been configured. The request message includes at least one of an indication that the procedure is initiated for L1/L2 mobility, or an indication that the procedure is initiated for a type of L1/L2 mobility. The type of L1/L2 mobility comprises at least one of a mobility triggered by network (“NW”), a mobility triggered by the CU, a mobility triggered by the DU, or a mobility triggered by a user equipment (“UE”).

The method further includes sending, from the CU to the DU, one or more triggering events by which the DU can trigger the L1/L2 mobility. The method further includes receiving, at the CU from the DU, one or more triggering events by which the CU can trigger the L1/L2 mobility. The method further includes: sending, from the CU to the DU, a configuration message for the L1/L2 mobility to be sent to the UE, wherein the configuration message includes at least one of the candidate cell list or the identified at least one of the candidate cells and configurations for each of the candidate cells, or one or more execution conditions for each of the candidate cells; and receiving, from the UE, through the DU, a confirmation of the configuration message. The method further includes: sending, from the CU to the DU, at least one of the candidate cells to request the DU to activate the candidate cells via the L1/L2 mobility. The DU sends L1/L2 signaling to the UE to indicate at least one of the candidate cells to be activated via the L1/L2 mobility.

The method further includes receiving at least one of the candidate cells at the CU from the DU, to identify that at least one of the candidate cells that has been successfully activated via the L1/L2 mobility. The DU receives L1/L2 signaling from the UE to identify that at least one of the candidate cells has been successfully activated via L1/L2 mobility. The method further includes sending an indication from the CU to the DU, to indicate to the DU to stop sending L1/L2 signaling for triggering the L1/L2 mobility. The method further includes sending an indication from the CU to the DU, to indicate to the DU to restart sending L1/L2 signaling for triggering the L1/L2 mobility. The CU and the DU are part of a basestation for communicating with a user equipment (“UE”), further wherein the L1/L2 signaling is communicated with the UE. The CU provides for upper layer support including PDCP and RRC layer; wherein the DU provides for lower layer support including RLC, MAC and Physical layer; wherein one or more DUs are configured to link with one shared CU.

In another embodiment, a wireless communications method includes: receiving a request message that includes a plurality of candidate cells at a distributed unit (“DU”) from a centralized unit (“CU”), to request the DU to configure at least one of the candidate cells for a Layer 1 or Layer 2 (“L1/L2”) signaling based mobility (“L1/L2 mobility”); and sending, from the DU to the CU, a response message that includes a list of candidate cells and configurations for each of the candidate cells, wherein the candidate cell list is used for identifying at least one of the candidate cells that has been configured. The request message includes at least one of an indication that the procedure is initiated for the L1/L2 mobility, or an indication that the procedure is initiated for a type of the L1/L2 mobility. The type of the L1/L2 mobility comprises at least one of a mobility triggered by network (“NW”), a mobility triggered by the CU, a mobility triggered by the DU, or a mobility triggered by a user equipment (“UE”).

The method further includes receiving, at the DU from the CU, one or more triggering events by which the DU can trigger the L1/L2 mobility. The method further includes sending, from the DU to the CU, one or more triggering events by which the CU can trigger the L1/L2 mobility. The method further includes: receiving, at the DU from the CU, a configuration message for the L1/L2 mobility, wherein the configuration message includes at least one of the candidate cell list or the identified at least one of the candidate cells and configurations for each of the candidate cells, or one or more execution conditions for each of the candidate cells; sending the configuration message for L1/L2 mobility from the DU to the UE; and receiving, at the DU from the UE, a confirming of the configuration message; and sending, from the DU to the CU, a confirmation of the configuration message. The method further includes receiving at least one of the candidate cells at the DU from the CU, to request the DU to activate the candidate cells via the L1/L2 mobility. The method further includes sending a L1/L2 signaling from the DU to the UE, to indicate at least one of the candidate cells to be activated via the L1/L2 mobility. The method further includes receiving a L1/L2 signaling, at the DU from the UE, to identify that at least one of the candidate cells which has been successfully activated via the L1/L2 mobility. The method further includes sending at least one of the candidate cells, from the DU to the CU, to identify that at least one of the candidate cells which has been successfully activated via the L1/L2 mobility. The method further includes: receiving an indication at the DU from the CU, that the DU should stop sending L1/L2 signaling for triggering L1/L2 mobility; and stopping sending L1/L2 signaling for triggering the L1/L2 mobility from the DU to the UE. The method further includes: receiving an indication at the DU from the CU, that indicates the DU should restart sending L1/L2 signaling for triggering the L1/L2 mobility; and restarting the sending of the L1/L2 signaling for triggering the L1/L2 mobility from the DU to the UE. The CU and DU are part of a basestation for communicating with a user equipment (“UE”), further wherein the L1/L2 signaling is communicated with the UE. The CU provides for upper layer support including PDCP and RRC layer; wherein the DU provides for lower layer support including RLC, MAC and Physical layer; wherein one or more DUs are configured to link with a shared CU.

In another embodiment, a wireless communications method includes: receiving a configuration message that includes a plurality of candidate cells with configurations for each and a measurement configuration for at least one of the candidate cells; and performing a measurement for the at least one candidate cell that is based on the measurement configuration. The method further includes: receiving a command identifying at least one of the candidate cells based on the measurement; and triggering a Layer 1 or Layer 2 (“L1/L2”) mobility from a current serving cell to the identified candidate cell that is based on the command and the configuration of the identified candidate cell. The method further includes: evaluating the measurements for the candidate cells to identify at least one of the candidate cells; and triggering a Layer 1 or Layer 2 (“L1/L2”) mobility from a current serving cell to the identified candidate cell that is based on evaluating whether the measurements of the identified candidate cell satisfies execution conditions and configuration of the identified candidate cell;
wherein the execution conditions are included in the configuration message for each of the candidate cells. The performing the measurement, evaluating the measurement, or triggering a L1/L2 mobility is performed at equipment (“UE”),
further wherein the UE receives the configuration message or the command from a basestation. The measurement configuration comprises at least one of a Layer 1 (“L1”) measurement configuration or a Layer 3 (“L3”) measurement configuration for at least one of the candidate cells or a neighbor cell.

The L1 measurement configuration includes a reference signal (“RS”) resource of each candidate cell or neighbor cell, wherein the RS resource includes: a RS resource identification; and at least one of a synchronization signal block (“SSB”) resource, a channel state information reference signal (“CSI-RS”) resource, or a temporary reference signal (“TRS”) resource. The RS resource for the candidate cell or the neighbor cell is configured within a set of RS resource for a current serving cell or is configured through a separate structure for listing the RS resource for the candidate cell or the neighbor cell. The L1 measurement configuration comprises a threshold for L1 Reference Signal Received Power (“RSRP”) measurements of serving cell to control the L1 measurement for the candidate cell or neighbor cell. The method further includes performing, by the UE, a L1 measurement for the candidate cell or the neighbor cell, when determining the L1 RSRP measurement result of the serving cell becomes worse than a threshold.

The L1 measurement configuration includes a report configuration for triggering a measurement report based on the L1 measurement for the candidate cell or the neighbor cell, wherein the report configuration comprises a report configuration identification and a measurement reporting type. The measurement reporting type comprises a type of reporting triggered based on measurement reporting events, wherein the measurement reporting events comprises the L1 measurement of neighbor cell becomes better than a threshold, the L1 measurements of the neighbor cell becomes better than the L1 measurements of a serving cell added a offset, the L1 measurements of the serving cell becomes worse than a first threshold and the L1 measurements of the neighbor cell becomes better than a second threshold, or the L1 measurements of the serving cell becomes worse than the first threshold and the L3 measurements of the neighbor cell becomes better than the second threshold. The method further includes triggering the measurement report, based on comparing whether the measurements for at least one of candidate cells or neighbor cells meet at least one of the measurement reporting events. The method further includes receiving a second command identifying at least one of the at least one RS resources identification, or the at least one cell identification of the candidate cells or the neighbor cells. The method further includes: performing the measurement based on the identified RS resources identification or cell identification of the candidate cell or the neighbor cell; or reporting the measurement based on the identified RS resources of identified RS resources identification or cell identification of the candidate cell or the neighbor cell. The command or the second command is a Layer 1 or Layer 2 (“L1/L2”) signaling, wherein the L1 signaling comprises a downlink control information (“DCI”), and the L2 signaling comprises a medium access control element (“MAC CE”). The L3 measurement configuration comprises a list of measurement information, wherein the measurement information comprises at least one of a candidate cell identification, or a cell basis offset based on the L3 measurement threshold for the candidate cell. The L3 measurement configuration comprises a list of measurement information that comprises at least one of a candidate cell identification a list of frequency information, or a list of measurement object information. The frequency information comprises at least one of a frequency, or a frequency basis offset based on the L3 measurement threshold for the candidate cell; wherein the measurement object information comprises at least one of a measurement object identification, or a measurement object basis offset based on the L3 measurement threshold for the candidate cell. The method further includes applying, the L3 measurement configuration associated with the identified candidate cell, based on the triggering of L1/L2 mobility to the identified candidate cell.

In another embodiment, a wireless communications method includes: transmitting a configuration message that includes a plurality of candidate cells with configurations for each and a measurement configuration for at least one of the candidate cells; and receiving a measurement report for the at least one candidate cell that is based on the measurement configuration. The method further includes transmitting a command identifying at least one of the candidate cells based on the measurement report, wherein the command is configured to trigger a Layer 1 or Layer 2 (“L1/L2”) mobility from a current serving cell to the identified candidate cell that is based on the command and the configuration of the identified candidate cell. The transmitting the configuration message and the command is from a basestation to a user equipment (“UE”), and the basestation receives the measurement report from the UE. The measurement configuration comprises at least one of a Layer 1 (“L1”) measurement configuration or a Layer 3 (“L3”) measurement configuration for at least one of the candidate cells or a neighbor cell. The method further includes: a RS resource identification; and at least one of a synchronization signal block (“SSB”) resource, a channel state information reference signal (“CSI-RS”) resource, or a temporary reference signal (“TRS”) resource. The RS resource for the candidate cell or the neighbor cell is configured within a set of RS resource for a current serving cell or is configured through a separate structure for listing the RS resource for the candidate cell or the neighbor cell. The L1 measurement configuration comprises a threshold for L1 Reference Signal Received Power (“RSRP”) measurements of serving cell to control the L1 measurement for the candidate cell or neighbor cell. The L1 measurement configuration comprises a report configuration for triggering a measurement report based on the L1 measurement for the candidate cell or the neighbor cell. The report configuration comprises a report configuration identification and a measurement reporting type.

The measurement reporting type comprises a type of reporting triggered based on measurement reporting events, wherein the measurement reporting events comprises the L1 measurement of neighbor cell becomes better than a threshold, the L1 measurements of the neighbor cell becomes better than the L1 measurements of a serving cell added a offset, the L1 measurements of the serving cell becomes worse than a first threshold and the L1 measurements of the neighbor cell becomes better than a second threshold, or the L1 measurements of the serving cell becomes worse than the first threshold and the L3 measurements of the neighbor cell becomes better than the second threshold. The method further includes transmitting a second command identifying at least one of the at least one RS resources identification or the at least one cell identification of the candidate cell or the neighbor cell. The method further includes receiving the measurement based on the identified RS resources of identified RS resources identification or the identified cell identification of the candidate cell or the neighbor cell. The command or the second command is a Layer 1 or Layer 2 (“L1/L2”) signaling, wherein the L1 signaling comprises a downlink control information (“DCI”), and the L2 signaling comprises a medium access control element (“MAC CE”). The L3 measurement configuration comprises a list of measurement information, wherein the measurement information comprises at least one of a candidate cell identification, or a cell basis offset based on the L3 measurement threshold for the candidate cell. The L3 measurement configuration comprises a list of measurement information that comprises at least one of a candidate cell identification, a list of frequency information, or a list of measurement object information. The frequency information comprises at least one of a frequency or a frequency basis offset based on the L3 measurement threshold for the candidate cell; wherein the measurement object information comprises at least one of a measurement object identification, or a measurement object basis offset based on the L3 measurement threshold for the candidate cell.

In one embodiment, a wireless communications apparatus comprises a processor and a memory, and the processor is configured to read code from the memory and implement any of the embodiments discussed above.

In one embodiment, a computer program product comprises a computer-readable program medium code stored thereupon, the code, when executed by a processor, causes the processor to implement any of the embodiments discussed above.

In some embodiments, there is a wireless communications apparatus comprising a processor and a memory, wherein the processor is configured to read code from the memory and implement any methods recited in any of the embodiments. In some embodiments, a computer program product comprising a computer-readable program medium code stored thereupon, the code, when executed by a processor, causing the processor to implement any method recited in any of the embodiments. The above and other aspects and their implementations are described in greater detail in the drawings, the descriptions, and the claims.

### BRIEF DESCRIPTION OF THE DRAWINGS

FIG. 1 shows an example basestation.

FIG. 2 shows an example random access (RA) messaging environment.

FIG. 3 shows a network architecture of a basestation Central Unit (CU) and basestation Distributed Unit (DU).

FIG. 4 shows an embodiment of user equipment (UE) intra-DU mobility.

FIG. 5 shows an embodiment of user equipment (UE) intra-CU and inter-DU mobility.

FIG. 6 shows an embodiment of user equipment (UE) inter-CU mobility.

FIG. 7 shows an embodiment of network triggered inter-cell mobility.

FIG. 8 shows an embodiment of user equipment (UE) triggered inter-cell mobility.

FIG. 9 shows an embodiment of intra-DU mobility based on CU initiated candidate cell preparation.

FIG. 10 shows an embodiment of intra-DU mobility based on DU initiated candidate cell preparation.

FIG. 11 shows an embodiment of inter-DU mobility based on CU initiated candidate cell preparation.

FIG. 12 shows an embodiment of inter-DU mobility based on DU initiated candidate cell preparation.

FIG. 13 shows an embodiment of intra-DU mobility based on CU triggering determination.

FIG. 14 shows an embodiment of intra-DU mobility based on DU triggering determination.

FIG. 15 shows an embodiment of intra-DU mobility based on UE triggering determination.

FIG. 16 shows an embodiment of inter-DU mobility based on CU triggering determination.

FIG. 17 shows an embodiment of inter-DU mobility based on DU triggering determination.

FIG. 18 shows an embodiment of inter-DU mobility based on UE triggering determination.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Radio resource control (“RRC”) is a protocol layer between UE and the basestation at the IP level (Network Layer). There may be various Radio Resource Control (RRC) states, such as RRC connected (RRC_CONNECTED), RRC inactive (RRC_INACTIVE), and RRC idle (RRC_IDLE) state. RRC messages are transported via the Packet Data Convergence Protocol (“PDCP”). As described, UE can transmit data through a Random Access Channel (“RACH”) protocol scheme or a Configured Grant (“CG”) scheme. CG may be used to reduce the waste of periodically allocated resources by enabling multiple devices to share periodic resources. The basestation or node may assign CG resources to eliminate packet transmission delay and to increase a utilization ratio of allocated periodic radio resources. The CG scheme is merely one example of a protocol scheme for communications and other examples, including but not limited to RACH, are possible. The wireless communications described herein may be through radio access.

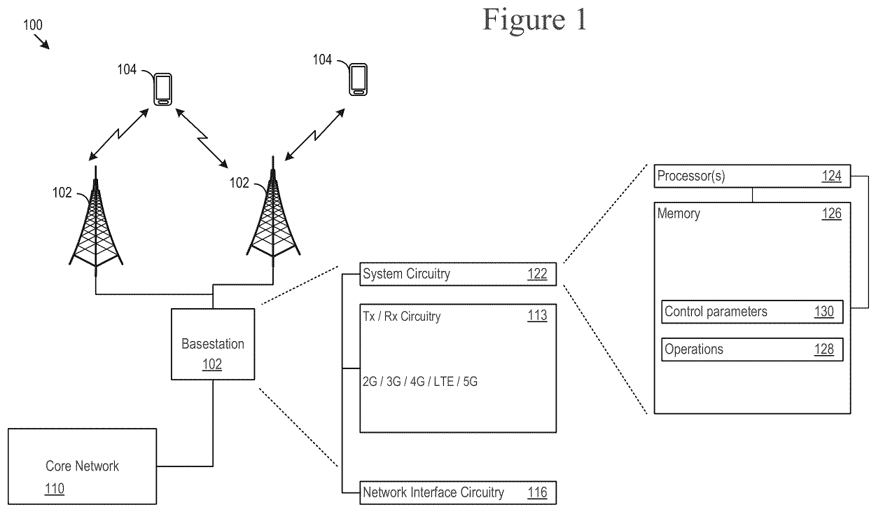

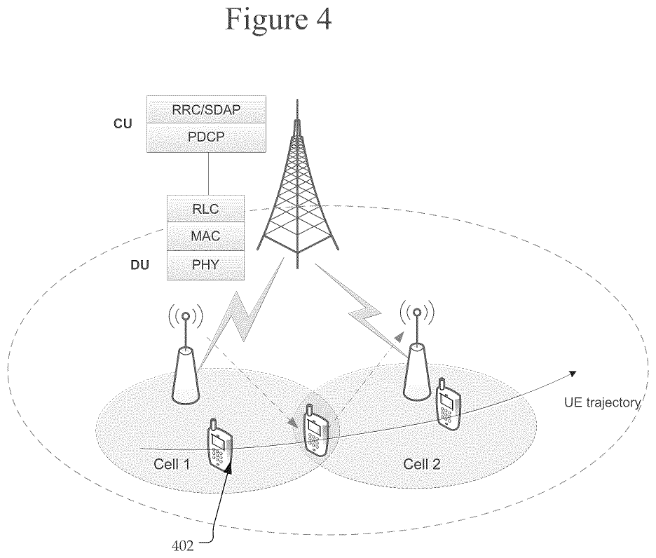

As described below with respect to FIGS. 1-6, a network provider may include a number of network nodes (i.e. basestations) for providing network access to a user equipment (“UE”) device. The network nodes are referred to as basestations in some embodiments. FIGS. 4-6 illustrate cell mobility in which the UE device moves between cells. Control signaling may be used to facilitate this mobility. Control signaling supports the transmission of downlink and uplink transport channels and may be referred to as layer 1 and/or layer 2 (“L1/L2”) signaling, indicating that the corresponding information partly originates from the physical layer (Layer 1) and partly from the medium access control (MAC) (Layer 2). Specifically, layer 1 may include the PHYSICAL Layer, while layer 2 may include MAC, RLC and PDCP. L1/L2 mobility based on L1/L2 signaling may have lower latency, lower overhead, and reduced interruption time.

There may be a master node (“MN”) and one or more secondary nodes (“SN”). The MN may include a master cell group (“MCG”) and the SN may each include a secondary cell group (“SCG”). The MCG is the group of cells provided by the master node (“MN”) and the SCG is the group of cells provided by the secondary node (“SN”). The MCG may include a primary cell (“PCell”) and one or more secondary cells (“SCell”). The SCG may include a primary secondary cell (“PSCell”) and one or more secondary cells (“SCell”). Each primary cell may be connected with multiple secondary cells. The primary cells (PCell, PSCell) are the master cells of their respective groups (MCG, SCG, respectively) and may initiate initial access. The primary cells may be used for signaling and may be referred to as special cell (“spCell”) where spCell=PCell+PSCell. The mobility between cells described in these embodiments may be based on the PCell, PSCell, and/or SCell

A user equipment (“UE”) device may move between nodes or cells in which case a handover or a change/addition operation may occur to improve network reliability for the UE as it moves. The movement may be from a source cell to a target cell based on a number of potential target cells that are referred to as candidates. The movement between cells may also include a number of target cells that are potential candidate cells. A conditional handover (“CHO”) and a conditional PSCell addition/change (“CPAC”) are described below. The CPAC may include a conditional PSCell change (“CPC”) and/or a conditional PSCell addition (“CPA”).

A conditional handover (“CHO”) can reduce handover interruption time and improve mobility reliability. A CHO is a handover that is executed by the UE when one or more execution conditions are met. The UE can evaluate the execution condition(s) upon receiving the CHO configuration, and can stop evaluating the execution condition(s) once the handover is triggered. The CHO configuration may include a candidate PCell configuration generated by a candidate target node and the corresponding execution condition(s) for that candidate cell.

A conditional PSCell addition/change (“CPAC”) may include the UE having a network configuration for initiating access to a candidate PSCell, either to consider whether the PSCell is suitable for SN addition or SN change including an intra-SN change. This consideration may be based on configured condition(s). The UE in the wireless network can operate in dual connectivity (“DC”), including intra-E-UTRA DC or Multi-Radio DC (“MR-DC”). In the example of intra-E-UTRA DC, both the MN and SN provide E-UTRA access. While in the example of MR-DC, one node may provide new radio (“NR”) access and the other one provides either E-UTRA or NR access.

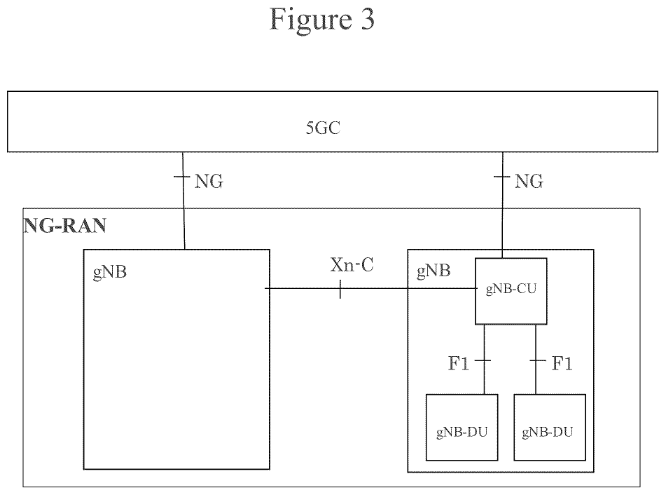

FIG. 1 shows an example basestation 102. The basestation may also be referred to as a wireless network node and may be the network nodes (e.g. master node (“MN”), secondary node (“SN”), and the source/target nodes) shown in FIGS. 3A-7B. The basestation 102 may be further identified to as a nodeB (NB, e.g., an eNB or gNB) in a mobile telecommunications context. The example basestation may include radio Tx/Rx circuitry 113 to receive and transmit with user equipment (UEs) 104. The basestation may also include network interface circuitry 116 to couple the basestation to the core network 110, e.g., optical or wireline interconnects, Ethernet, and/or other data transmission mediums/protocols.

The basestation may also include system circuitry 122. System circuitry 122 may include processor(s) 124 and/or memory 126. Memory 126 may include operations 128 and control parameters 130. Operations 128 may include instructions for execution on one or more of the processors 124 to support the functioning the basestation. For example, the operations may handle random access transmission requests from multiple UEs. The control parameters 130 may include parameters or support execution of the operations 128. For example, control parameters may include network protocol settings, random access messaging format rules, bandwidth parameters, radio frequency mapping assignments, and/or other parameters.

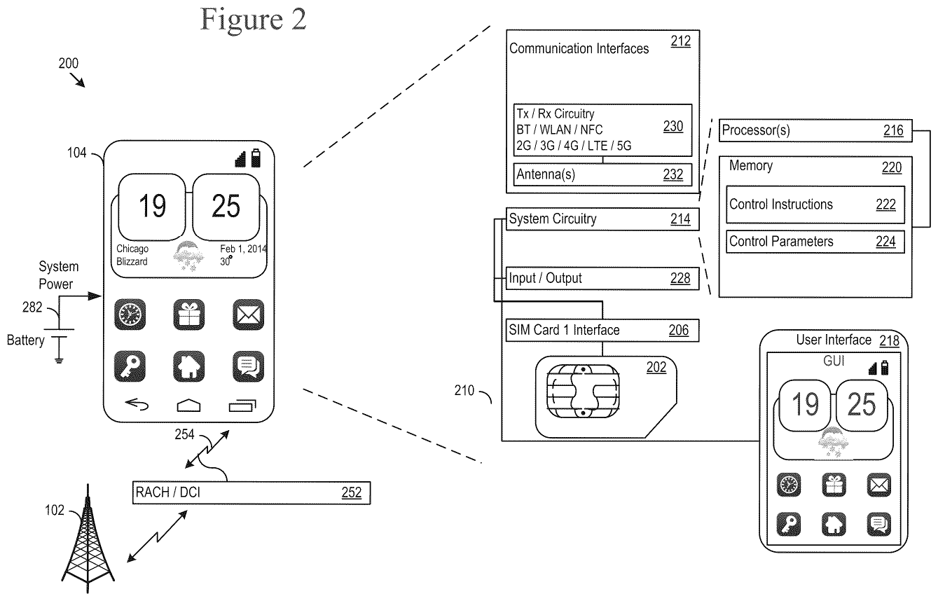

FIG. 2 shows an example random access messaging environment 200. In the random access messaging environment a UE 104 may communicate with a basestation 102 over a random access channel 252. In this example, the UE 104 supports one or more Subscriber Identity Modules (SIMs), such as the SIM1 202. Electrical and physical interface 206 connects SIM1 202 to the rest of the user equipment hardware, for example, through the system bus 210.

The mobile device 200 includes communication interfaces 212, system logic 214, and a user interface 218. The system logic 214 may include any combination of hardware, software, firmware, or other logic. The system logic 214 may be implemented, for example, with one or more systems on a chip (SoC), application specific integrated circuits (ASIC), discrete analog and digital circuits, and other circuitry. The system logic 214 is part of the implementation of any desired functionality in the UE 104. In that regard, the system logic 214 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, Internet connectivity; establishing, maintaining, and terminating wireless network connections, Bluetooth connections, or other connections; and displaying relevant information on the user interface 218. The user interface 218 and the inputs 228 may include a graphical user interface, touch sensitive display, haptic feedback or other haptic output, voice or facial recognition inputs, buttons, switches, speakers and other user interface elements. Additional examples of the inputs 228 include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

The system logic 214 may include one or more processors 216 and memories 220. The memory 220 stores, for example, control instructions 222 that the processor 216 executes to carry out desired functionality for the UE 104. The control parameters 224 provide and specify configuration and operating options for the control instructions 222. The memory 220 may also store any BT, WiFi, 3G, 4G, 5G or other data 226 that the UE 104 will send, or has received, through the communication interfaces 212. In various implementations, the system power may be supplied by a power storage device, such as a battery 282

In the communication interfaces 212, Radio Frequency (RF) transmit (Tx) and receive (Rx) circuitry 230 handles transmission and reception of signals through one or more antennas 232. The communication interface 212 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium.

The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 212 may include transceivers that support transmission and reception under the 2G, 3G, BT, WiFi, Universal Mobile Telecommunications System (UMTS), High Speed Packet Access (HSPA)+, and 4G/Long Term Evolution (LTE) standards. The techniques described below, however, are applicable to other wireless communications technologies whether arising from the 3rd Generation Partnership Project (3GPP), GSM Association, 3GPP2, IEEE, or other partnerships or standards bodies.

Multiple RAN nodes of the same or different radio access technology (“RAT”) (e.g. eNB, gNB) can be deployed in the same or different frequency carriers in certain geographic areas, and they can inter-work with each other via a dual connectivity operation to provide joint communication services for the same target UE(s). The multi-RAT dual connectivity (“MR-DC”) architecture may have non-co-located master node (“MN”) and secondary node (“SN”). Access Mobility Function (“AMF”) and Session Management Function (“SMF”) may the control plane entities and User Plane Function (“UPF”) is the user plane entity in new radio (“NR”) or 5GC. The signaling connection between AMF/SMF and the master node (“MN”) may be a Next Generation-Control Plane (“NG-C”)/MN interface. The signaling connection between MN and SN may an Xn-Control Plane (“Xn-C”) interface. The signaling connection between MN and UE is a Uu-Control Plane (“Uu-C”) RRC interface. All these connections manage the configuration and operation of MR-DC. The user plane connection between User Plane Function (“UPF”) and MN may be NG-U (MN) interface instance.

FIG. 3 shows a network architecture of a basestation Central Unit (CU) and basestation Distributed Unit (DU). FIG. 3 illustrates basestations (labeled as “gNB”) that communicate with an overall network (labeled (“5GC”). Basestations can communicate with one another via a control plane interface (“Xn-C”). One basestation is shown as have one CU that is connected to two DUs via an F1 interface. This is merely one example of an arrangement of a basestation. In some embodiments, there may be one or any number of DUs connected with a single CU.

The basestation can be divided into two physical entities named Centralized Unit (“CU”) and Distributed Unit (“DU”). Generally, the CU may provide support for the higher layers of the protocol stack such as SDAP, PDCP and RRC while the DU provides support for the lower layers of the protocol stack such as RLC, MAC and Physical layer. The CU may include operations for a transfer of user data, mobility control, radio access network sharing, session management, etc., except those functions allocated exclusively to the DU. The DU(s) are logical node(s) with a subset of the basestation functions, and may be controlled by the CU.

The CU may be a logical node hosting RRC, SDAP and PDCP protocols of the basestation or RRC and PDCP protocols of the basestation that controls the operation of one or more DUs. The DU may be a logical node hosting RLC, MAC and PHY layers of the basestation, and its operation may be at least partly controlled by the CU. A single DU may support one or multiple cells. However, each cell is only supported by a single DU. Each basestation may support many cells. As described in the embodiments herein, the cell mobility between cells may be from different CUs or DUs or may be internal to the CU and/or the DU.

### L1/L2 Mobility

The L1/L2 based inter-cell mobility described herein may occur in a number of different examples. For L1/L2 mobility, there may be intra-DU mobility where a UE changes cells within a single DU. Examples of intra-DU mobility include: 1) PCell change within one DU (may also include PCell change with SCell change); 2) PSCell change within one DU (may also include PSCell change with SCell change); and 3) PCell change within one DU with PSCell change within one DU (may also include SCell change within one cell group). In another L1/L2 mobility embodiment, there may be intra-CU and inter-DU mobility where a UE changes cells between different DUs but within a single CU. Examples of intra-CU and inter-DU mobility include: 1) PCell change across DU but within one CU (may also include PCell change with SCell change); and 2) PSCell change across DU but within one CU (may also include PSCell change with SCell change). In another L1/L2 mobility embodiment, there may be inter-CU mobility where a UE changes cells between different CUs. Examples of inter-CU mobility include: 1) PCell change across CU (may also include PCell change with SCell change); and 2) PSCell change across CU (may also include PSCell change with SCell change). In another embodiment, there may be a SCell change/addition and this example may include the SCell addition/change within one cell group. FIGS. 4-6 illustrate embodiments of UE mobility between cells.

FIG. 4 shows an embodiment of user equipment (UE) intra-DU mobility. The basestation may include a CU and at least one DU. In this embodiment, there is a single DU shown that has multiple cells. Both Cell 1 and Cell 2 are from the single DU. In this example, the UE 402 can move from Cell 1 to Cell 2 and is depicted in FIG. 4 with a UE trajectory from Cell 1 to Cell 2. The mobility from cells may occur when the UE 402 is in a position between the two cells and making its way to the third position within Cell 2. This is intra-DU mobility because the UE is moving cells within a single DU.

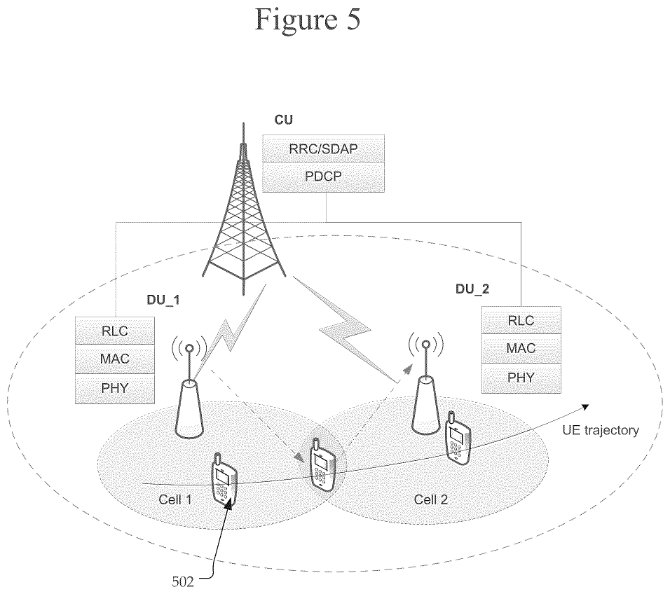

FIG. 5 shows an embodiment of user equipment (UE) intra-CU and inter-DU mobility. In this embodiment, the basestation may include a CU and two DUs (DU_1 and DU_2). Although each DU may have multiple cells, for this example each DU is shown providing a single cell such that DU_1 is providing Cell 1 and DU_2 is providing Cell 2. In this example, the UE 502 can move from Cell 1 to Cell 2 and is depicted in FIG. 5 with a UE trajectory from Cell 1 to Cell 2 which also results in a transition from DU_1 to DU_2. The mobility from cells may occur when the UE 402 is in a position between the two cells and making its way to the third position within Cell 2. This is intra-CU mobility because the UE is moving cells within a single CU. However, this is also inter-DU mobility because the UE is moving between different DUs.

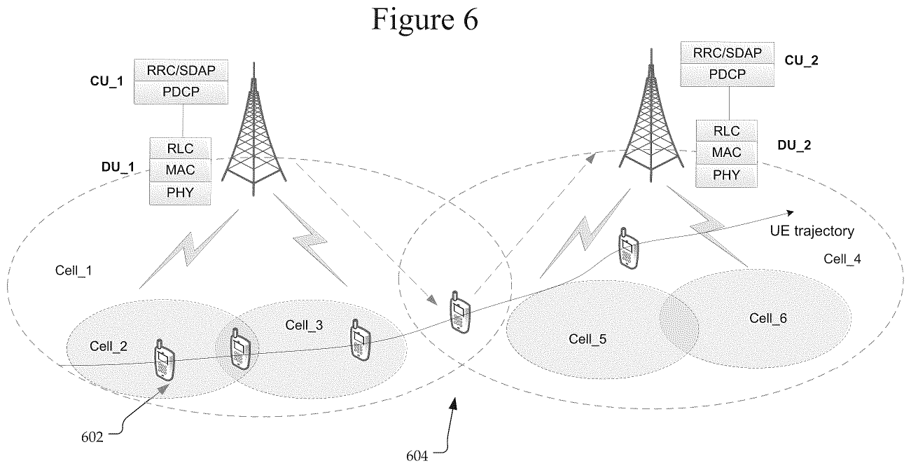

FIG. 6 shows an embodiment of user equipment (UE) inter-CU mobility. In this embodiment, the basestation may include multiple CUs (CU_1 and CU_2). Each CU may include multiple DUs, but in this example, each CU is shown as having one corresponding DU (CU_1 has DU_1 and CU_2 has DU_2). Each of the DUs is shown with multiple cells. In this example, the UE trajectory of the UE 602 passes from Cell_2 to Cell_3 to an inter-CU position 604 (between CU_1 and CU_2) to Cell_5 and Cell_6. As the UE moves, the mobility may change cells as shown and may transition between a number of cells. Because the UE 602 (at the inter-CU position 604) switches cells from CU_1 to CU_2, this transition is referred to as inter-CU mobility.

### Network Triggered L1/L2 Mobility

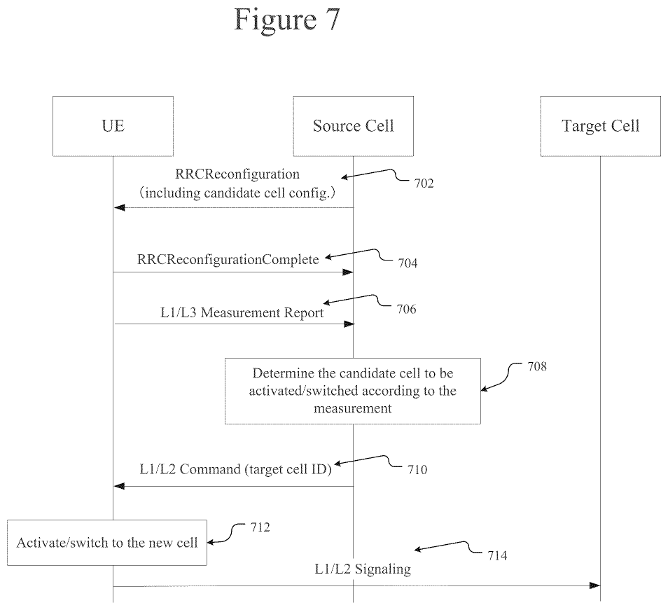

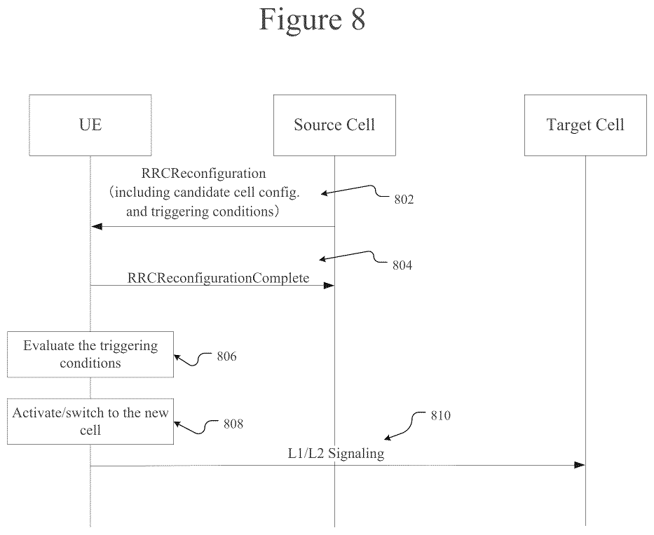

The mobility between cells can be triggered by the network (e.g. the basestation) or by the UE. As described, L1/L2 signaling is used for improved mobility between cells. The examples described throughout may be triggered by the network or by the UE and the embodiments shown in FIGS. 7-8 may be applicable to the other embodiments.

FIG. 7 shows an embodiment of network triggered inter-cell mobility. This embodiment illustrates communications or signaling between the UE, a source cell, and a target cell. The communication shows how the UE can move from the source cell to the target cell and the L1/L2 signaling that is used as part of the transition. In block 702, the network (“NW”) pre-configures one or multiple candidate/neighbor cells for inter-cell mobility via RRC signaling (e.g. a RRCReconfiguration message). The candidate cell configuration may include a plurality of candidates to act as the target cell. Further embodiments and examples are described below about the candidate list and about the what the configuration can include. In block 704, the UE responds to the RRC message with a confirmation/complete message to the network at the source cell. The message may be a RRCReconfigurationComplete in one embodiment. In block 706, the UE reports to the network L1 and/or L3 measurements related to neighbor cells (i.e. potential candidate cells). Further embodiments and examples are described below about the measurements and the neighbor/candidates.

In one embodiment, the source cell of the network determines at least one of the candidate cell to be activated based on the measurement in block 708. The candidate cell to be activated may also be referred to as the identified cell or the identified candidate cell. The identification process is further described below. Based on the identification of at least one target cell, the source cell sends a triggering command in block 710 to the UE that includes the identification of at least one target cell. This triggering command is a L1/L2 command. Based on receipt of this L1/L2 command, the UE switches to the target cell in block 712 and communicates with the target cell in block 714. The communication between the UE and the target cell is through L1/L2 signaling. As described, using L1/L2 signaling for cell mobility may provide several advantages. In some embodiments, the configuration details of the neighbor/candidate cells (including the target cell) may be provided for identifying or determining the target cell. This information may further be used after identification by the UE for establishing the L1/L2 communication in block 714.

### UE Triggered L1/L2 Mobility

The mobility between cells can be triggered by the network (e.g. the basestation) or by the UE. As described, L1/L2 signaling is used for improved mobility between cells. The examples described throughout may be triggered by the network or by the UE and the embodiments shown in FIGS. 7-8 may be applicable to the other embodiments.

FIG. 8 shows an embodiment of user equipment (UE) triggered inter-cell mobility. This embodiment illustrates communications or signaling between the UE, a source cell, and a target cell. The communication shows how the UE can move from the source cell to the target cell and the L1/L2 signaling that is used as part of the transition. In block 802, the network (“NW”) pre-configures one or multiple candidate/neighbor cells for inter-cell mobility via RRC signaling (e.g. a RRCReconfiguration message). The candidate cell configuration may include a plurality of candidates to act as the target cell. Further, the configuration message includes triggering conditions that are used by the UE for triggering the mobility based also on the configurations for the candidate cells. Further embodiments and examples are described below about the candidate list, the configurations, and the triggering conditions. In block 804, the UE responds to the RRC message with a confirmation/complete message to the network at the source cell. The message may be a RRCReconfigurationComplete in one embodiment.

For the UE triggered example, the UE evaluates the triggering conditions in block 806. The evaluation of the triggering conditions is used for identifying a target cell from among the candidate cells in block 808. The triggering conditions may also be referred to as execution conditions. Specifically, if at least one candidate cell satisfies the triggering conditions then the UE can switch to that candidate cell. In other words, the UE may not switch to a candidate cell if that candidate cell has not satisfied the triggering conditions. The identifying in block 808 may also include activating or switching to the target cell, and the UE can communicate with the target cell in block 810. The communication between the UE and the target cell is through L1/L2 signaling. As described, using L1/L2 signaling for cell mobility may provide several advantages. In some embodiments, the configuration details of the neighbor/candidate cells (including the target cell) may be provided for identifying or determining the target cell. This information may further be used after identification by the UE for establishing the L1/L2 communication in block 810.

### Candidate Cell Configuration

As described with respect to FIGS. 7-8, the candidate cells may include configurations that are transmitted. The configurations may include configuration parameters that are provided for identifying a candidate cell (e.g. target cell). The candidate cell configuration may include the lower layer configuration (e.g. RLC layer configuration, MAC layer configuration, or/and physical layer configuration). In some embodiments, the candidate cell configuration may include at least one of the following information elements (IEs): CellCroupConfig, SpCellConfig, ServingCellConfigCommon and/or ServingCellConfig.

The candidate cell configuration may be provided via different options. In one embodiment, each candidate cell configuration can be included in one RRC container, and linked with the cell identification (ID) information (e.g. like CHO/HO based solution). In other embodiments, the candidate cell configuration may be included as a cell list in the RRC message and each cell configuration may be linked with the cell identification information (e.g. like a cell activation/deactivation based solution).

The cell ID information used for the configuration and maintenance of candidate cells may include a candidate cell configuration index (e.g. CandReconfigId), a candidate/serving cell ID, (e.g. ServCellIndex), a physical cell ID (PCI), a PCI+frequency, or a reference signal (RS) ID related to the candidate cell (e.g. the RS ID linked with the candidate cell via PCI, which has been configured as part of the current serving cell configuration). The RS may be at least one of Synchronization Signal Block (SSB), Channel State Information (CSI) reference signal (CSI-RS), Temporary/Tracking Reference Signal (TRS). In other embodiments, a Transmission Configuration Indicator (TCI) state ID related to the candidate cell may also be used. The TCI state may be linked with the candidate cell (e.g. via PCI) and has been configured as part of the current serving cell configuration.

The candidate cells stored can be activated as a SpCell or a SCell. In some embodiments, the cell can be activated as both. Examples of when the activation is as SpCell, SCell, or both are described below.

In one embodiment for identifying the candidate cell, there may be a separate structure/list for the candidate SpCell (i.e. PCell, PSCell) and candidate SCell, e.g. a candidate SpCell list (e.g. candidateSpCellToAddModList, candidateSpCellToReleaseList) and a candidate SCell list (e.g. candidateSCellToAddModList, candidateSCellToReleaseList).

In another embodiment for identifying the candidate cell, there may be a common structure/list for the candidate cells (e.g. candidateCellToAddModList, candidateCellToReleaseList), and each entry may be configured as either a candidate SpCell or a candidate SCell. In this example, there may be an indicator/flag used to indicate whether the cell can be a candidate SpCell or a candidate SCell (e.g. candidateCellType, candidateSpCell, or candidateSCell). In another alternative of this example, there may be different cell ID ranges assigned for a candidate SpCell and a candidate SCell (e.g. value 0˜X are assigned for a candidate SpCell, while value X+1˜N are assigned for candidate SCell). In another alternative of this example, there may be a bitmap used to indicate which cells can be activated as SpCell (e.g. a bit in the bitmap set to 1 indicates that the cell can be activated as SpCell). In another alternative of this example, there may be a SpCell specific configuration (e.g. SpCellConfig, reconfiguration WithSync, PUCCH-Config) in the candidate cell configuration that can be used to distinguish whether the candidate cell can be activated as SpCell or SCell. For example, if the candidate cell configuration includes a SpCell specific command, the candidate cell is used as a candidate SpCell. Otherwise, it is used as a candidate SCell.

In another embodiment for identifying the candidate cell, there may be a common structure/list for the candidate cells (e.g. candidateCellToAddModList, candidateCellToReleaseList), and each entry may be configured as candidate cell for both SpCell and SCell. In an alternative example for this embodiment, for the entry including (e.g. SpCell specific configuration(s) (e.g. SpCellConfig, reconfiguration WithSync, PUCCH-Config), the associated candidate cell can be used as both a candidate SpCell and a candidate SCell. Otherwise, the entry may be used as a candidate SCell. In another alternative example for this embodiment, the entry includes two sub-entries, one sub-entry contains the configuration used for candidate SpCell (e.g. including SpCell specific configuration(s)), while the other sub-entry contains the configuration used for candidate SCell (e.g. without SpCell specific configuration(s)). It may be up to the network (“NW”) to determine how to use the candidate cell as a SpCell or a SCell.

In another embodiment, an indicator or flag in the L1/L2 command that triggers the mobility may also indicate whether the cell is activated as a SpCell. The SpCell specific configuration may be used/applied by the UE when the cell is activated as a SpCell.

In some embodiments, the NW may also provide information about which cells can be activated simultaneously. The candidate cell mapping/combination information can be provided via several different ways. In one example, there may be a cell combination list (e.g. candidateCellCombinationList) to indicate which candidate cells can be activated simultaneously. Each item in the list may include a cell combination ID (to identify any potential cell combination), and/or a cell combination containing multiple candidate cell IDs. In another example, there may be a bitmap to indicate which candidate cells can be activated simultaneously (e.g. the bitmap is of size N bits to indicate N candidate cells). A bit in the bitmap set to 1 indicates that the cell can be activated simultaneously or a bit set to 0 indicates the cell cannot be activated simultaneously.

TABLE 1
Bitmap of whether candidate cells can be activated simultaneously.

| Cell_1 | Cell_2 | Cell_3 | Cell_4 |
|---|---|---|---|
| 1 | 1 | 1 | 0 |
| 1 | 0 | 1 | 1 |
| 1 | 1 | 0 | 1 |

In this example with 4 candidate cells pre-configured by the NW, only 1+2+3, 1+3+4, 1+2+4 are allowed to be activated simultaneously. The NW can provide the above bitmap table as part of the configuration. Alternatively, the NW may provide a list of candidate cell ID combination, e.g. {Cell_1, Cell_2, Cell_3}, {Cell_1, Cell_3, Cell_4}, {Cell_1, Cell_2, Cell_4}.

There may be various embodiments to reduce the signaling overhead for the candidate cell configuration. In one embodiment, one or more separate common set/template(s) are defined as a baseline for the candidate cell configuration, and configured candidate cell(s) based on the baseline configuration and delta configuration add to the baseline configuration. In another embodiment, one or more serving/candidate cell(s) are identified as reference cell(s) (e.g. including an reference ID for the current serving cell ID or other candidate cell ID) in the candidate cell configuration entry in the candidate cell list, and configured candidate cell(s) based on the configuration of the referenced cell and delta configuration to the referenced cell configuration. This embodiment may also be considered for reusing the serving cell as the candidate cell, or vice versa. Specifically, including a reference cell indicator (e.g. referenceCell) in the candidate cell configuration or the serving cell configuration. For example, for a candidate cell entry, a serving cell ID (e.g. SCellIndex or ServCellIndex) may be included to indicate that the referred serving cell is also considered as a candidate cell for L1/L2 mobility. A candidate cell ID may be indicated in the current serving cell configuration (e.g. SpCellConfig or SCellConfig) to indicate that the candidate cell is added as serving cell (e.g. via the RRC reconfiguration message).

### L1/L3 Measurement

FIG. 7 illustrated an L1/L3 measurement being used for a measurement report that helps determine/identify the target cell from the candidate cells. In some embodiments, the L1/L3 measurement configuration may be provided by the network to the UE.

The NW may provide the L1 measurement configuration for candidate or neighbor cells to the UE via at least one of the following alternatives: 1) configure/add L1 measurements for candidate cells in the current L1 measurement configuration on the serving cell (e.g. Channel State Information measurement configuration CSI-MeasConfig); 2) configure or reuse L1 measurements for candidate cells in the RRM measurement configuration (e.g. MeasConfig); 3) define a separate structure to provide L1 measurements for candidate cells; or 4) the L1 measurements configuration for the candidate cell is configured or included in each candidate cell configuration.

The L1 measurement configuration may include at least one of the following items: an add/modify list for L1 measurement object/resource; a remove list for L1 measurement object/resource; an add/modify list for L1 measurement ID (measurement ID is a linking of a measurement object/resource and a report configuration); a remove list for L1 measurement ID; an add/modify list for L1 report configuration; a remove list for L1 report configuration; a measurement gap configuration for L1 measurement; or a threshold for SpCell/serving cell RSRP measurement controlling when the UE is required to perform L1 measurements on non-serving/candidate cells (e.g. L1 SSB RSRP threshold, or L1 CSI-RS RSRP threshold). When the serving cell becomes worse than the threshold, the UE may be required to perform L1 measurements on non-serving/candidate/neighbor cells. Those measurements are then used for selecting/identifying a target cell from amongst the candidate cells.

The L1 measurement can be provided or activated in different embodiments. The measurement may be referred to as an object/resource (e.g. reference signal resources used for L1 measurement). It may be provided in the following alternatives: 1) configure or add a reference signal (RS) resource related to candidate/neighbor cells in the L1 measurement configuration for the current serving cell (e.g. CSI-ResourceConfig); 2) reuse the RS resource related to candidate/neighbor cells in L3/RRM measurements or configure/add additional RS resources related to candidate/neighbor cells in the L3/RRM measurement configuration (e.g. CSI-RS-ResourceConfigMobility); 3) define a separate structure to provide RS resource for candidate/neighbor cells; or 4) the RS resource for the candidate cells is configured/included in each candidate cell configuration. The RS type may include at least one of SSB, CSI-RS, TRS. In some embodiments, the RS resources may include at least one of the following: 1) the RS resource ID; 2) the frequency domain resource of the RS; 3) the time domain resource of the RS; or 4) the resource type (e.g. aperiodic, semi-persistent, or periodic). For the configured RS measurement resources activation, the RS/measurement resource may be considered as activated (e.g. can be detectable or measured by the UE) when it is configured or the RS/measurement resource is considered as deactivated (e.g. cannot be detectable or measured by the UE) when it is configured. The NW may explicitly indicate which RS resources related to the neighbor/candidate cell (e.g. indicating RS resource ID, candidate cell ID) are to be activated (e.g. via L1/L2 command or RRC signaling). When the RS resources related to the neighbor/candidate cell are activated, the UE may be required to perform L1 measurement on that RS resources related to the neighbor/candidate cell. When the RS resources related to the neighbor/candidate cell are deactivated, the UE is not required to perform L1 measurement on that RS resources related to the neighbor/candidate cell.

The L1 measurement report can be configured in different ways. The L1 measurement report configuration (e.g. CSI-ReportConfig) may be used to configure a L1 measurement report on the current serving cell. It may include at least one of a report configuration ID, or a report type (e.g. aperiodic, semiPersistent, periodic, or event triggered). For the event triggered type, the triggering event may be established as a new event based on L1 measurements. For example, the L1 measurements of a neighbor cell becomes better than threshold value (e.g. an A4event, RSRP, RSRQ and/or SINR value). In another example, the L1 measurements of a neighbor cell becomes offset better than the L1 measurements of a SpCell/serving cell (e.g. A3 event). In another example, the L1 measurements of SpCell/serving cell becomes worse than a first threshold and the L1 measurements of neighbor cell becomes better than a second threshold (e.g. A5 event). The L1 measurement report can be further configured by reusing the L3-based measurement events (e.g. events A3/A4/A5), but configured with additional parameter values (e.g. additional hysteresis, timeToTrigger, threshold) for L1/L2 mobility. A more flexible value may make L1/L2 mobility be triggered more easily. The L1 measurement report can be further configured by new events based on the L1 measurements on serving cell and L3 measurements on candidate/neighbor cells. For example, the L1 measurements of SpCell/serving cell becomes worse than a first threshold and the L3 measurements of neighbor cells become better than a second threshold (e.g. A5-like event).

The L1 measurement gap can be configured to specify a window in which the UE can perform inter-frequency and/or intra-frequency L1 measurements. The measurement gap may be provided by reusing the measurement gap configuration for L3/RRM measurement (e.g. MeasGapConfig). Additional parameter values may be configured for L1 measurement (e.g. additional gapOffset, mgl, mgrp, mgta, etc.). An offset value may be based on the parameter value for L3 measurement (e.g. offset values for gapOffset, mgl, mgrp, mgta, etc.). The L1 measurement gap can be configured to define a separate measurement gap configuration for L1 measurement (e.g. L1MeasGapConfig). The L1 measurement gap configuration may include at least one of the following items:
a gap type (e.g. per FR1 gap, per FR2 gap, per UE gap);
a gap offset;
a measurement gap repetition period;
a measurement gap length;
a measurement gap timing advance; or
a reference serving cell whose SFN and subframe are used for gap calculation for this gap pattern.

In FIG. 8, the triggering condition is provided to the UE. The triggering condition may also be referred to as an execution condition and establishes a condition or threshold by which the mobility may be triggered. In one embodiment, the triggering condition includes a list of measurement identifiers measIds, which may be linked with an L1/L3 measurement object/resource and report configuration as described above. In another embodiment, the triggering condition includes any of the measurement events listed above.

The candidate cell may be linked with the triggering condition. Specifically, one or more execution conditions are linked with one candidate cell. In another embodiment, one or more execution conditions are linked with multiple candidate cells (e.g. one or more conditions for a candidate cell combination including both SpCell and associated SCells). If multiple conditions are linked with the candidate cell/cell combination, the UE may consider the conditions met when all conditions are met (e.g. each condition relationship is “AND”) or when one of conditions is met (e.g. each condition relationship is “OR”).

The configured Radio Resources Management (RRM) measurement may be impacted by the execution of L1/L2 mobility (e.g. a change between inter-frequency measurement and infra-frequency measurement). The trigger event on the UE side (e.g. for other candidate cell or CHO, if coexistence with CHO is allowed) shall be considered to ensure the event is still valid after the execution of L1/L2 mobility. The updated RRM measurement configuration (e.g. measurement object configuration, measurement report configuration, measurement gap configuration) may be provided differently in various embodiments. In one embodiment, the NW pre-configures the updated measurement configuration associated with each candidate cell to the UE. For example, the measurement configuration is included in each candidate cell configuration, or a separate structure for measurement configuration update is defined (e.g. a list of measurement configuration, each one is linked with the candidate cell ID). Upon triggering the L1/L2 based mobility, the UE applies the corresponding measurement configuration of the target cell. In another embodiment, the UE automatically triggers the measurement configuration switch upon triggering the L1/L2 based mobility, or upon successful completion of the mobility (e.g. the measId is associated with measObjectId value corresponding to the source frequency is linked to the measObjectId value corresponding to the target frequency). In another embodiment that combines the embodiments described above, the NW pre-configures part of the updated measurement configuration (e.g. gap configuration, report configuration) associated with each candidate cell to the UE. Upon triggering the L1/L2 based mobility, the UE performs automatic mobility switch and applies the corresponding measurement configuration of the target cell based on the baseline/source measurement configuration.

For the report configuration (e.g. including the triggering/execution condition) update, the source configuration can be stored as a template/baseline, or the NW provides a separate set of report configurations as a template/baseline. The NW provides a set of delta configurations for each candidate cell, which can be applied based on the template/baseline when triggering the L1/L2 mobility. The delta configuration may include a list of cell basis offset value (e.g. RSRP, RSRQ, SINR value), each one associated with each candidate cell. When a candidate cell is selected/indicated to be activated/switched as a target cell, the UE adds the cell basis offset value associated with the cell to the threshold/offset value within the template/baseline configuration to generate the new report configuration for the target cell. An example signaling structure is shown in Table 2 below:

In Table 2, the measurement information for the delta configuration comprises a list of candidate cell ID and the associated cell basis offset value. The delta configuration may further include a set of frequency/MO basis offset value (e.g. RSRP, RSRQ, SINR value) for each candidate cell. When a candidate cell is selected/indicated to be activated/switched as a target cell, the UE adds the frequency basis offset value associated with the cell to the threshold/offset value linked with the corresponding frequency within the template/baseline configuration. An example signaling structure is shown in Table 3 below:

In Table 3, the measurement information for the delta configuration comprises a list of candidate cell ID and the associated measurement object/frequency information list. Each measurement object/frequency information comprises a list of measurement object ID or frequency and the associated measurement object/frequency value.

For providing the measurement gap configuration update, there may be a list of measurement gap configuration (e.g. measGapConfigList) that are each linked with a set of candidate cells, such as a candidate cell list within the GapConfig. In another embodiment providing the measurement gap configuration update, there may be a list of candidate cells, each one linked with one or a set of measurement gap configuration. In another embodiment providing the measurement gap configuration update, there may be a template/baseline measurement gap configuration (e.g. the source measurement gap configuration), a list of update measurement configuration is the delta configuration based on the template/baseline. When one candidate cell is activated, the UE autonomously applies/activates the associated measurement gap configuration.

### Triggering by the Network for L1/L2 Mobility

Referring back to FIG. 7, the L1/L2 mobility may be triggered by the network. In block 706, the L1/L3 measurements related to neighbor cells (including candidate cells) are reported by the UE to the NW. The NW selects the target candidate cell based on the measurements report in block 708 and sends a triggering command (e.g. L1/L2 command) in block 710 to indicate that the UE selects the indicated cell to perform inter-cell mobility. Further examples of the triggering of the L1/L3 measurement report are described below. The UE can trigger the L1/L3 measurement report upon meeting the condition/event for the configured report type (e.g. aperiodic, semiPersistent, periodic, or event triggered). For the aperiodic type, upon reception of a DCI trigger for L1 measurement report request, the UE shall send aperiodic L1 measurement reports (e.g. CSI report) on PUSCH. For a semiPersistent type, upon reception of a DCI trigger for L1 measurement report request, the UE may send semi-persistent L1 measurement reports (e.g. CSI report) on PUSCH. For a semiPersistent type, upon reception of a MAC CE for L1 measurement report request, the UE shall send a semi-persistent L1 measurement reports (e.g. CSI report) on PUCCH. For a periodic type, the UE shall send periodic L1 measurement reports (e.g. CSI report) on PUCCH according to the configured/defined periodicity. For an event triggered type, upon determination/detection of the L1 measurements meeting the configured condition/event, the UE shall send L1 measurement reports (e.g. via CSI report or MAC CE).

In an alternative embodiment, the UE can trigger the L1/L3 measurement report upon detection of N consecutive L1 measurements meeting the conditions (e.g. for event triggered type above). In an alternative embodiment, the UE can trigger the L1/L3 measurement report upon detection of N consecutive “out-of-sync” indications for the SpCell/serving cell from lower layer (i.e. detection of physical layer problem). In an alternative embodiment, the UE can trigger the L1/L3 measurement report upon detection of radio link failure (RLF) or beam failure recovery (BFR) on the SpCell/serving cell, e.g. T310 expiry, T312 expiry, random access problem, reaching the maximum number of retransmissions, or listen before talk (LBT) failure.

The measurement report can be sent by L1 signaling (e.g. via CSI report) or via MAC CE. The measurement report may include at least one of the following: L1 SSB RSRP, L1 SSB RSRQ, L1 SSB SINR, L1 CSI-RS RSRP, L1 CSI-RS RSRQ, L1 CSI-RS SINR for the neighbor/candidate cell or/and the serving cell. The NW can also indicate which measurements related to the neighbor/candidate cell (e.g. via RS resource ID, candidate cell ID) are requested to be reported, e.g. via L1/L2 command (Downlink Control Information (DCI), MAC Control Element (MAC CE)). The UE may send the measurement report that only includes the measurement results for the indicated neighbor/candidate cell.

The triggering command can be at least one of a physical layer DCI, MAC CE or RRC signaling. The triggering command may include at least one of the following information of the one or more selected cells to indicate that the UE actives or switches to the indicated cell(s):
Candidate cell configuration index (e.g. like CandReconfigId);
Candidate/Serving cell ID (e.g. like ServCellIndex);
PCI or PCI+frequency;
Reference signal (RS) ID related to the candidate cell, e.g. the RS ID linked with the candidate cell (e.g. via Physical Cell ID (PCI)) has been configured as part of the current serving cell configuration. The RS can be at least one of Synchronization Signal Block (SSB), Channel State Information Reference Signal (CSI-RS), Tracking/Temporary Reference Signal (TRS);
Transmission Configuration Indicator (TCI) state ID related to the candidate cell (e.g. the TCI state linked with the candidate cell via PCI) has been configured as part of the current serving cell configuration; or
Candidate cell combination ID (e.g. to indicate which candidate cells can be activated simultaneously).
   The triggering command may also include at least one of the following information:
The Timing Advance (TA) value or compensatory TA value of the selected/indicated candidate cell(s);
The Cell Radio Network Temporary Identifier (C-RNTI) of the selected/indicated candidate cell(s);
Activation DL/UL BWP ID of the selected/indicated candidate cell(s);
An indication/flag to indicate whether the UE can maintain the connection with the source/current SpCell/serving cell during L1/L2 based inter-cell mobility (i.e. like DAPS HO);
An indication or flag to indicate whether RACH procedure towards the selected/indicated candidate cell(s) is needed/skipped or whether RACH-less procedure is allowed;
Initial TCI state(s) of the selected/indicated candidate cell(s);
Serving cell ID(s) for the selected/indicated candidate cell(s);
A PDCP duplication activation/deactivation indication, to indicate whether the PDCP duplication is activated/maintained/deactivated after completion of L1/L2 based inter-cell mobility; or
An indication or flag to indicate whether the selected/indicated candidate cell(s) is activated as a SpCell.

### Triggering by the UE for L1/L2 Mobility

Referring back to FIG. 8, the L1/L2 mobility may be triggered by the user equipment (UE). The UE starts evaluating the execution/triggering condition(s) for the candidate cell in block 806. If at least one candidate cell satisfies the corresponding execution condition(s), the UE connects to the target candidate cell in block 808 based on the stored cell configuration. The L1/L2 mobility execution may be triggered when at least one of the following conditions is met:
upon at least one candidate cell/cell combination satisfies the corresponding execution condition(s);
upon at least one candidate cell/cell combination N consecutively satisfies the corresponding execution condition(s);
upon detection of N consecutive “out-of-sync” indications for the SpCell/serving cell from lower layer (i.e. detection of physical layer problem); or
upon detection radio link failure (RLF) or beam failure recovery (BFR) on the SpCell/serving cell (e.g. T310 expiry, T312 expiry, random access problem, reach of the maximum number of RLC retransmissions, or LBT failure).

### UE Behavior Upon Triggering

The example discussed above is for UE triggering, but the following discussion of UE behavior upon triggering L1/L2 based inter-cell mobility may also apply to both UE triggered mobility and NW triggered mobility. Upon triggering the L1/L2 based inter-cell mobility (e.g. upon reception of L1/L2 triggering command or upon detection of the execution condition(s) is met), the UE may perform at least one of the following operations:
applies/activates the stored cell configuration of the indicated/selected candidate/target cell(s);
applies/activates the stored SpCell configuration (i.e. the configuration including SpCell specific configuration(s)) of the indicated/selected candidate/target cell(s) when the cell is indicated to be activated as SpCell by the NW (e.g. via an indication in the triggering command);
applies the new TA value or applies the compensatory TA value based on the current TA value for the indicated/selected candidate/target cell(s), if indicated by the NW (e.g. via an indication in the triggering command);
applies the C-RNTI or/and serving cell ID(s) for the indicated/selected candidate/target cell(s), if indicated by the NW (e.g. via an indication in the triggering command);
switches to/actives the uplink (UP)/downlink (DL)/bandwidth part (BWP) according to the activation DL/UL BWP identifier (ID), if indicated by the NW (e.g. via an indication in the triggering command);
starts a timer for L1/L2 mobility (e.g. a MAC layer timer or a RRC layer timer, like T304);
detaches from the source/current SpCell/serving cell, synchronizes and connects to the indicated/selected candidate/target cell(s); or
maintains the connection source/current SpCell/serving cell, synchronizes and connects to the indicated/selected candidate/target cell(s), if indicated by the NW (e.g. via an indication in the triggering command).

For a connection to the target cell, the UE may perform the following processes. In one embodiment, if RACH-less is not configured/allowed, the UE accesses the target cell via RACH procedure (e.g. CBRA, CFRA, 2-step RA) and completes the L1/L2 based inter-cell mobility procedure by sending L1/L2 signaling to the target cell. In an alternative embodiment, when a RACH-less is configured/allowed (e.g. via an indication in the triggering command), then the UE sends the L1/L2 signaling to the target cell via pre-allocated uplink grant. In another embodiment, the UE monitors the Physical Downlink Control Channel (PDCCH) of the target cell to receive the uplink grant and the UE sends L1/L2 signaling to the target cell via the received uplink grant. In another embodiment, the UE sends Scheduling Request (SR) to the target cell and starts monitoring PDCCH of the target cell to receive the uplink grant and the UE sends L1/L2 signaling to the target cell via the received uplink grant. In another embodiment, the UE monitors the PDCCH of the target cell with indicated TCI states in the received L1/L2 triggering command, to receive the uplink grant and the UE sends the L1/L2 signaling to the target cell via the received uplink grant. In another embodiment, the UE sends SR to the target cell and starts monitoring PDCCH of the target cell with indicated TCI states in the received L1/L2 triggering command, to receive the uplink grant and the UE sends the L1/L2 signaling to the target cell via the received uplink grant.

The L1/L2 signaling may be at least one of a physical layer Uplink Control Information (UCI), ACK, or MAC CE. The L1/L2 signaling may also include the activated/selected candidate/target cell ID(s) or the activated/selected candidate cell combination ID to the NW.

In order to switch between the current/source serving cell to the target cell, a switch is performed between the candidate cell ID and the serving cell ID. Upon triggering L1/L2 based inter-cell mobility, the UE can automatically perform the switch between the candidate cell ID (which is used for the configuration and maintenance of candidate cells) and a serving cell ID (which is used for the subsequent cell operation, such as in SCell activation/deactivation MAC CE) if the serving cell ID(s) is not explicitly provided by the NW (e.g. not pre-configured with the candidate cell configuration or/and not indicated in the triggering command). For each candidate cell, if the candidate cell is activated as PCell, the UE sets the serving cell ID for that cell as 0 (i.e ServCellIndex=0), but if the candidate cell is activated as SCell or PSCell, the UE uses the candidate cell ID that has previously been assigned for the candidate cell (e.g. the candidate cell ID included in the RRC message with the candidate cell configuration) as the serving cell ID (i.e. ServCellIndex=candidate cell ID).

### L1/L2 Mobility Failure Detection/Handling

A new timer may be used for L1/L2 based inter-cell mobility (e.g. T304-like timer). The timer may be a RRC layer timer or a MAC layer timer. In one embodiment, the timer starts upon triggering L1/L2 based inter-cell mobility (e.g. reception of the L1/L2 command, or upon execution of UE triggered L1/L2 mobility (i.e. when applying a stored candidate cell configuration or upon detection that the execution condition is met)). The timer stops when at least one of the following conditions is met:
Upon successful completion of L1/L2 based inter-cell mobility, e.g. successful completion of random access on the corresponding candidate cell, or sending the L1/L2 indication (e.g. UCI, ACK, MAC CE) to the corresponding candidate/target cell;
Upon detection of RLF/BFR on the current/source serving cell;
Upon release of the candidate cell configuration;
When RRC layer informs MAC layer to stop the timer when the timer is set as a MAC layer timer; or.
When MAC layer informs RRC layer about the successful completion of the L1/L2 based inter-cell mobility when the timer is a RRC layer timer.

When the timer is a MAC layer timer and the timer expires, the UE can trigger/send a MAC CE to report the L1/L2 mobility failure. In another embodiment, when the timer is a MAC layer timer and the timer expires, the UE can inform the upper layer (e.g. RRC layer) about the detection of L1/L2 mobility failure. Then RRC layer may then trigger RRC re-establishment procedure, report L1/L2 mobility failure to the NW, or select another candidate cell among the stored candidate cells to perform the second L1/L2 inter-cell mobility (e.g. activate or switch to a different candidate cell).

When the timer is a RRC layer timer and the timer expires, the UE can trigger RRC re-establishment procedure. In another embodiment, when the timer is a RRC layer timer and the timer expires, the UE can report the L1/L2 mobility failure to the NW. In another embodiment, when the timer is a RRC layer timer and the timer expires, the UE can select another candidate cell among the stored candidate cells to perform the second L1/L2 inter-cell mobility (e.g. activate or switch to a different candidate cell).

A L1/L2 mobility failure report described above can be sent to the NW via L1/L2 signaling (e.g. UCI, MAC CE), or via RRC signaling (e.g. reusing the exist RRC message including a FailureInformation message, MCGFailureInformation message, or SCGFailureInformation message) or by defining a new RRC message. The failure report may include a failure type (e.g. L1/L2 mobility failure) and/or a failed candidate cell ID(s) or a failed candidate cell combination ID information.

In one embodiment, there may be a CHO based recovery solution. If the UE fails to access the candidate cell, and detects at least one of other candidate cells satisfies the corresponding triggering condition or a separate condition/threshold set by the NW (e.g. a condition/threshold only used for cell selection during failure recovery), the UE can automatically trigger the second L1/L2 mobility to the selected candidate cell. If the failed cell is a candidate PCell, and the source cell connection is maintained during L1/L2 mobility (e.g. like DAPS), the UE can fall-back to the source cell and report the L1/L2 mobility failure to the source cell. If the failed cell is a candidate PSCell or a candidate SCell, the UE reports the failure information to the NW via RRC signalling (e.g. FailureInformation message, or SCGFailureInformation message) or MAC CE (e.g. a new failure report MAC CE).

When Packet Data Convergence Protocol (PDCP) duplication is configured for the UE, several alternatives may be considered for the handling of PDCP duplication upon triggering L1/L2 based inter-cell mobility or completion of L1/L2 based inter-cell mobility. In one embodiment, the UE autonomously deactivates PDCP duplication upon triggering L1/L2 mobility. In another embodiment, the NW explicitly indicates whether to activate/deactivate/maintain PDCP duplication (e.g. via L1/L2 mobility triggering command). In another embodiment, the UE autonomously switches primaryPath to refer to another logical channel (LCH) (e.g. the LCH linked with the activated candidate cell) if the previous LCH is removed (e.g. no serving cell is linked with the previous LCH) upon execution/completion of L1/L2 mobility.

### CU/DU Coordination

As described above with respect to FIG. 3, the network (NW) or basestation may include a Central Unit (CU) and Distributed Unit (DU). Generally, the CU may provide support for the higher layers of the protocol stack such as SDAP, PDCP and RRC while the DU provides support for the lower layers of the protocol stack such as RLC, MAC and Physical layer. The CU may include operations for a transfer of user data, mobility control, radio access network sharing, session management, etc., except those functions allocated exclusively to the DU. A single DU may support one or multiple cells. However, each cell is only supported by a single DU. The cell mobility between cells may be from different CUs or DUs or may be internal to the CU and/or the DU.

There are several examples as shown FIGS. 4-6. FIG. 4 shows an embodiment of intra-DU mobility. FIG. 5 shows an embodiment of intra-CU and inter-DU mobility. FIG. 6 shows an embodiment of inter-CU mobility. Within those examples, the mobility may be triggered by the network as in FIG. 7, or may be triggered by the user equipment (UE) as in FIG. 8. The NW triggered mobility from FIG. 7 may be further modified depending on whether it is DU triggered mobility or CU triggered mobility.

Specifically, the CU and DU coordinate to add/modify/release the candidate cell configuration and the triggering events. There are at least four embodiments for the coordination on candidate cell configuration initiation/preparation. In embodiment 1, the CU determines the suggested candidate cells, and the CU determines the triggering events. In embodiment 2, the CU determines the suggested candidate cells, and the DU determines the triggering events. In embodiment 3, the DU determines the suggested candidate cells, and the DU determines the triggering events. In embodiment 4, the DU determines the suggested candidate cells, and the CU determines the triggering events.

TABLE 5
Summary of Four Embodiments for CU/DU Initiation (candidate
cell suggestion) and CU/DU Triggering (event determination).

| Embodiment | Initiation | Triggering | Coordination procedure |
|---|---|---|---|
| 1 | CU | CU | CU → DU: suggested candidate cell list, may |
| | | | also provide triggering events |
| | | | DU → CU: accepted or failed candidate cell list, |
| | | | candidate cell configuration |
| 2 | CU | DU | CU → DU: suggested candidate cell list |
| | | | DU → CU: accepted or failed candidate cell list, |
| | | | candidate cell configuration, may also provide |
| | | | triggering events |
| 3 | DU | DU | DU → CU: suggested candidate cell list, may |
| | | | also provide candidate cell configuration, may |
| | | | also provide triggering events |
| | | | CU → DU: accepted or rejected candidate cell |
| | | | list |
| 4 | DU | CU | DU → CU: suggested candidate cell list, may |
| | | | also provide candidate cell configuration |
| | | | CU → DU: accepted or rejected candidate cell |
| | | | list, may also provide triggering events |

For embodiment 1 and embodiment 2 where the CU determines the suggested candidate cells, the CU sends a suggested candidate cell list to the DU via F1 message (e.g. UE CONTEXT MODIFICATION REQUEST message or other message), to request the DU to set up or configure. The message may also include an indication to indicate that the procedure is for L1/L2 mobility and/or an indication to indicate that the procedure is for which type of L1/L2 mobility (e.g. “UE triggered L1/L2 mobility”, “NW triggered L1/L2 mobility”, “CU triggered L1/L2 mobility” or “DU triggered L1/L2 mobility”). For embodiment 1, the CU may also send the triggering events to DU (e.g. for DU triggered mobility).

For embodiment 1 and embodiment 2 where the CU determines the suggested candidate cells, the DU sends a accepted or failed/rejected candidate cell list, and/or candidate cell configuration for each accepted candidate cell to CU via F1 message (e.g. UE CONTEXT MODIFICATION RESPONSE message or other message). If the DU accepts all suggested candidate cells, no accepted or failed/rejected candidate cell list is provided. If the DU fails to set up or configure some candidate cells, a failed/rejected candidate cell list (including the failed candidate cells) or a accepted candidate cell list (including the accepted candidate cells) is provided. The candidate cell configuration may be encapsulated in a RRC container (e.g. HandoverPreparationInformation, CG-Config or CG-ConfigInfo message). For embodiment 2, the DU may also send the triggering events to CU (e.g. for UE triggered mobility or CU triggered mobility).

For embodiment 3 and embodiment 4 where the DU determines the suggested candidate cells, the DU sends a request candidate cell list to CU via F1 message (e.g. UE CONTEXT MODIFICATION REQUIRED message or other message) to request CU to allow DU to set up. The message may also include an indication to indicate that the procedure is for L1/L2 mobility and/or an indication to indicate that the procedure is for which type of L1/L2 mobility (e.g. “UE triggered L1/L2 mobility”, “NW triggered L1/L2 mobility”, “CU triggered L1/L2 mobility” or “DU triggered L1/L2 mobility”). The DU may also provide the candidate cell configuration for each requested candidate cell. The candidate cell configuration may be encapsulated in a RRC container (e.g. HandoverPreparationInformation, CG-Config or CG-ConfigInfo message). For embodiment 3, the DU may also send the triggering events to CU (e.g. for UE triggered mobility or CU triggered mobility).

For embodiment 3 and embodiment 4 where the DU determines the suggested candidate cells, the CU sends an accepted or failed/rejected candidate cell list to the DU via F1 message (e.g. UE CONTEXT MODIFICATION CONFIRM message). If the CU accepts all requested candidate cells, no accepted or failed/rejected candidate cell list is provided. If the CU rejects some candidate cells, a failed/rejected candidate cell list (including the failed/rejected candidate cells) or a accepted candidate cell list (including the accepted candidate cells) is provided. For embodiment 4, the CU may also send the triggering events to DU (e.g. for DU triggered mobility).

The triggering events may include events based on L1 measurements. For example, when the L1 measurements of neighbor cells becomes better than threshold value (e.g. RSRP, RSRQ or/and SINR value for an A4-like event). In another example, when the L1 measurements of neighbor cell become offset better than the L1 measurements of SpCell/serving cell (e.g. A3-like event). In another example, when the L1 measurements of SpCell/serving cell become worse than a first threshold and the L1 measurements of a neighbor cell becomes better than a second threshold (e.g. A5-like event). In an alternative, the triggering events may include events based on the L1 measurements on serving cell and L3 measurements on candidate/neighbor cells, such as when the L1 measurements of SpCell/serving cell becomes worse than a first threshold and the L3 measurements of a neighbor cell becomes better than a second threshold (e.g. A5-like event). In another alternative, the triggering events may include a list of measId(s), which is linked with L1/L3 measurement object/resource and report configuration.

In the embodiments where information (e.g. triggering event(s), the indication for L1/L2 mobility) is provided, that information may be transferred to the CU or the DU with the information directly in a F1 message (e.g. UE CONTEXT MODIFICATION REQUEST/RESPONSE, UE CONTEXT MODIFICATION REQUIRED/CONFIRM message). In another embodiment, the information (e.g. triggering event(s), the indication for L1/L2 mobility) may be provided in a RRC message (e.g. HandoverPreparationInformation, CG-Config, or CG-ConfigInfo message). The RRC message may be included as one information element (IE) in a F1 message.

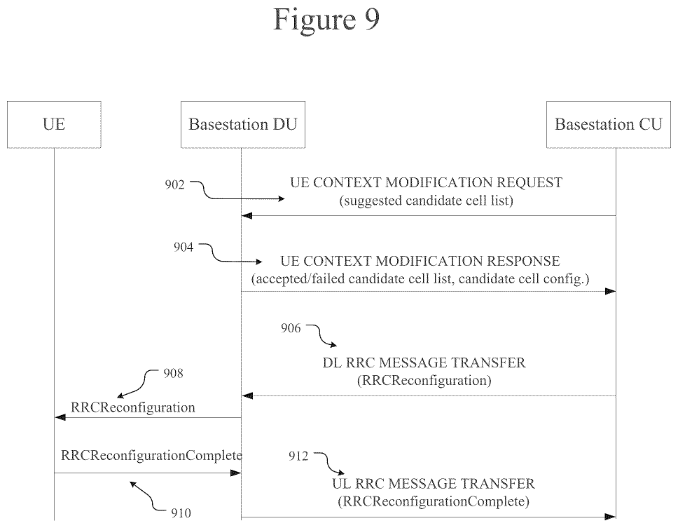

FIG. 9 shows an embodiment of intra-DU mobility based on CU initiated candidate cell preparation. FIG. 9 is applicable to Embodiment 1 and Embodiment 2 from Table 5. The user equipment (UE) communicates with a basestation distributed unit (DU) and a basestation centralized unit (CU). FIG. 4 illustrated intra-DU mobility while FIG. 9 shows intra-DU mobility based on CU initiated candidate cell preparation. In block 902, the CU determines the suggested candidate cell (e.g. according to the RRM measurements). The CU sends a suggested candidate cell list to the DU via F1 message (e.g. UE CONTEXT MODIFICATION REQUEST message or other message), to request DU to set up or configure candidate cells. The message may also include an indication to indicate that the procedure is for L1/L2 mobility, and/or an indication to indicate that the procedure is for which type of L1/L2 mobility.

In block 904, the DU determines whether to set up or configure the candidate cells as suggested, and sends the generated candidate cell configuration (e.g. CellGroupConfig) to the CU (e.g. via UE CONTEXT MODIFICATION RESPONSE message). If the DU fails to set up or configure some candidate cells, the DU may also include a accepted cell list (e.g. including a list of cell have been successfully set up) or a failed/rejected cell list (e.g. including a list of cell failed to set up) in the message. The DU may also include the generated triggering events/execution conditions in the message (e.g. for UE or CU triggered mobility).

In block 906, the CU sends the generated RRCReconfiguration message to the DU (e.g. via DL RRC MESSAGE TRANSFER message). The RRC message includes the candidate cell configuration and may also include the triggering events/conditions associated with the candidate cell(s) (e.g for UE triggered mobility). In block 908, the DU forwards the received RRCReconfiguration message to the UE. In block 910, the UE responds to the DU with an RRCReconfigurationComplete message, and then the DU forwards to the CU in block 912 (e.g. via an UL RRC MESSAGE TRANSFER message). In some embodiments, the CU sends the generated triggering events to the DU in block 906. In an alternative embodiment, blocks 906 and 912 may include a UE CONTEXT MODIFICATION REQUEST message and UE CONTEXT MODIFICATION RESPONSE message.

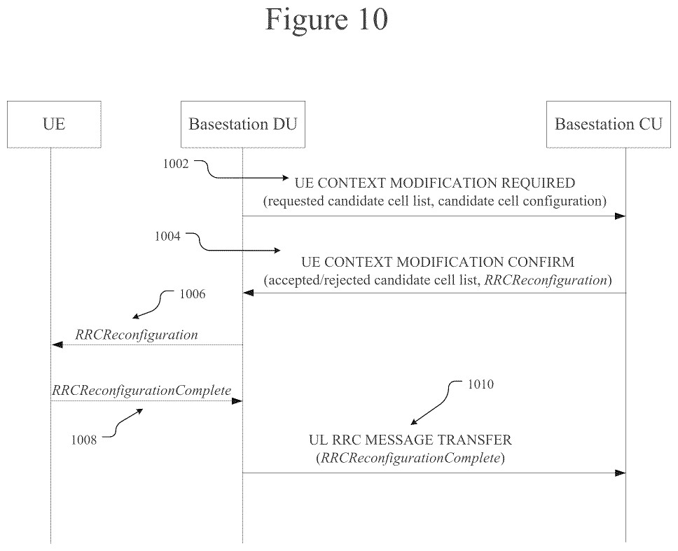

FIG. 10 shows an embodiment of intra-DU mobility based on DU initiated candidate cell preparation. FIG. 10 is applicable to Embodiment 3 and Embodiment 4 from Table 5. FIG. 4 illustrated intra-DU mobility while FIG. 10 shows intra-DU mobility based on DU initiated candidate cell preparation. In block 1002, the DU determines the suggested candidate cell (e.g. according to the L1 measurements). The DU sends a requested candidate cell list to the CU via F1 message (e.g. UE CONTEXT MODIFICATION REQUIRED message or other message) to request the CU to set up or configure the candidate cells. The DU may also include the generated candidate cell configuration (e.g. CellGroupConfig), and/or the triggering events (e.g. for CU or UE triggered mobility) in the message. The message may also include an indication to indicate that the procedure is for L1/L2 mobility, and/or an indication to indicate that the procedure is for which type of L1/L2 mobility.

In block 1004, the CU determines whether to accept the candidate cells as requested. If the CU rejects some candidate cells, the CU may also include an accepted cell list (e.g. including a list of cell ID that have been accepted) or a failed/rejected cell list (e.g. including a list of cell ID that have been rejected) in the message. The CU generates a RRCReconfiguration message, which include the candidate cell configuration for each accepted cell, and may also include the generated triggering events/execution conditions in the message (e.g. for UE triggered mobility) and sends the RRC message to the DU via F1 message (e.g. UE CONTEXT MODIFICATION CONFIRM message or other message). The F1 message may also include the triggering events to the DU (e.g. for DU triggered mobility).

In block 1006, the DU forwards the received RRCReconfiguration message to the UE. In block 1008, the UE responds to the DU with an RRCReconfigurationComplete message, for which the DU forwards to the CU in block 1010 (e.g. via an UL RRC MESSAGE TRANSFER message). In some embodiments, the DU may generate the triggering events after the CU accepts the required candidate cells (e.g. after block 1004) and send the generated triggering events to the CU via UE CONTEXT MODIFICATION REQUIRED message. Then the CU generates the RRC reconfiguration message and sends to the UE via the DU (e.g. sending the generated RRCReconfiguration message to the DU via DL RRC MESSAGE TRANSFER message), and the DU forwards the received RRCReconfiguration message to the UE.

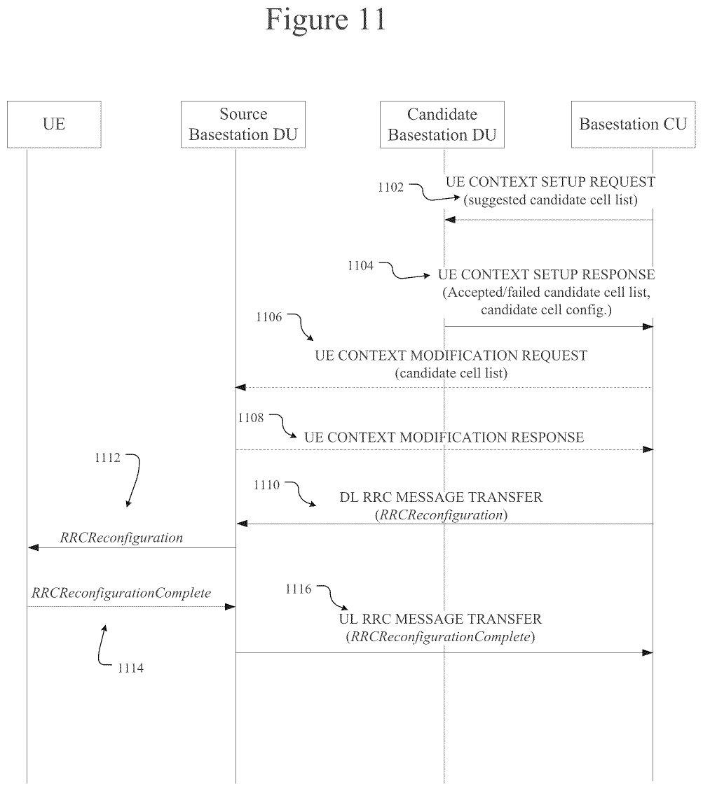

FIG. 11 shows an embodiment of inter-DU mobility based on CU initiated candidate cell preparation. FIG. 11 is applicable to Embodiment 1 and Embodiment 2 from Table 5. FIG. 5 illustrated inter-DU mobility while FIG. 11 shows inter-DU mobility based on CU initiated candidate cell preparation. There may be a source DU that the UE transfers from to the candidate DU (a/k/a target DU). In this example, the CU does not change because this is intra-CU inter-DU mobility.

In block 1102, the CU determines the suggested candidate cell (e.g. according to the RRM measurements). The CU sends a suggested candidate cell list to the candidate DU via F1 message (e.g. UE CONTEXT SETUP REQUEST message or other message) to request candidate DU to set up or configure candidate cells. The message may also include an indication to indicate that the procedure is for L1/L2 mobility, and/or an indication to indicate that the procedure is for which type of L1/L2 mobility. Before block 1102, in some embodiments, the CU may send an UE CONTEXT MODIFICATION REQUEST message to the source DU to query the latest configuration. The source DU responds with an UE CONTEXT MODIFICATION RESPONSE message that includes full configuration information.

In block 1104, the target DU determines whether to set up or configure the candidate cells as suggested, and sends the generated candidate cell configuration (e.g. CellGroupConfig) to the CU (e.g. via UE CONTEXT SETUP RESPONSE message). If the target DU fails to set up some candidate cells, the DU may also include an accepted cell list (e.g. including a list of cell have been successfully set up) or a failed/rejected cell list (e.g. including a list of cell failed to set up) in the message. In block 1106, the CU may send the configured candidate cell list to the source DU via F1 message (e.g. UE CONTEXT MODIFICATION REQUEST message). This message may also include the CU generated triggering events/execution conditions (e.g. for DU triggered mobility). In block 1108, the source DU responds with an UE CONTEXT MODIFICATION RESPONSE message. This message may also include the DU generated triggering events/execution conditions (e.g. for UE triggered mobility or CU triggered mobility).

In block 1110, the CU sends the generated RRCReconfiguration message to the DU (e.g. via DL RRC MESSAGE TRANSFER message). The RRC message includes the candidate cell configuration, and may also include the triggering events/conditions associated with the candidate cell(s) (e.g for UE triggered mobility). In block 1112, the DU forwards the received RRCReconfiguration message to the UE. In block 1114, the UE responds to the DU with an RRCReconfigurationComplete message, for which the DU forwards to the CU in block 1116 (e.g. via an UL RRC MESSAGE TRANSFER message). In some embodiments, blocks 1106, 1108 may be skipped. After block 1104, the CU can send the generated RRC reconfiguration message to the source DU (e.g. via UE CONTEXT MODIFICATION REQUEST message). The message may also include the configured candidate cell list and/or the CU generated triggering events/execution conditions (e.g for DU triggered mobility).

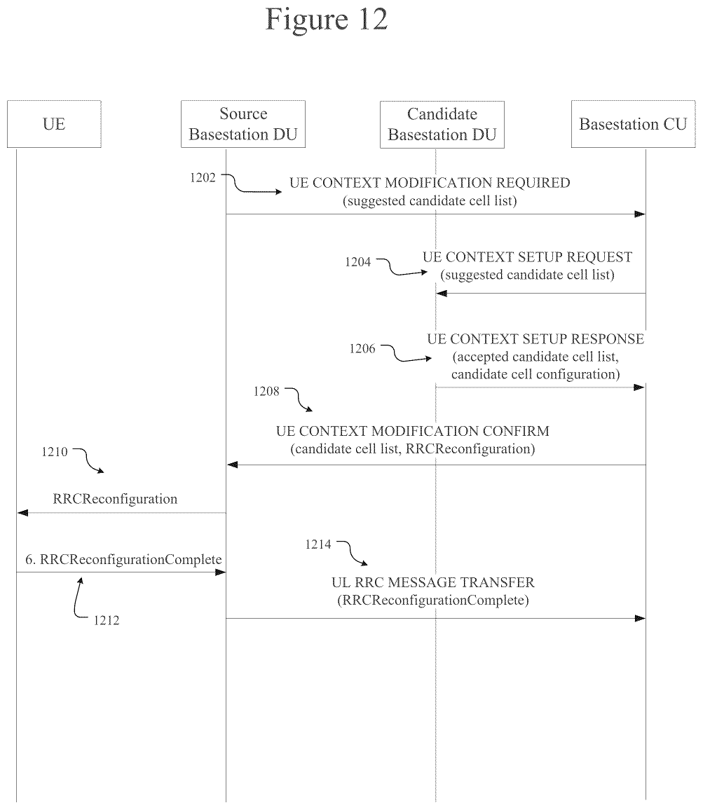

FIG. 12 shows an embodiment of inter-DU mobility based on DU initiated candidate cell preparation. FIG. 12 is applicable to Embodiment 3 and Embodiment 4 from Table 5. FIG. 5 illustrated inter-DU mobility while FIG. 12 shows inter-DU mobility based on DU initiated candidate cell preparation. In block 1202, the source DU determines the candidate cell (e.g. according to the L1 measurements). The DU sends a suggested candidate cell list, or/and candidate DU ID(s) to the CU via F1 message (e.g. UE CONTEXT MODIFICATION REQUIRED message or other message), to request set up candidate cells. The message may also include an indication to indicate that the procedure is for L1/L2 mobility, and/or an indication to indicate that the procedure is for which type of L1/L2 mobility.

In block 1204, the CU sends a suggested candidate cell list to the candidate DU via F1 message (e.g. UE CONTEXT SETUP REQUEST message or other message), to request candidate DU to set up candidate cells. The message may also include an indication to indicate that the procedure is for L1/L2 mobility, e.g. “L1/L2 mobility” indicator. In some embodiments, before block 1204, the CU may send an UE CONTEXT MODIFICATION REQUEST message to the source DU to query the latest configuration and the source DU responds with an UE CONTEXT MODIFICATION RESPONSE message that includes full configuration information.

In block 1206, the target DU determines whether to set up the candidate cells as suggested, and sends the generated candidate cell configuration (e.g. CellGroupConfig) to the CU (e.g. via UE CONTEXT SETUP RESPONSE message). If the target DU fails to set up some candidate cells, the DU may also include an accepted cell list (e.g. including a list of cell have been successfully set up) or a failed/rejected cell list (e.g. including a list of cell failed to set up) in the message. In block 1208, the CU sends the generated RRCReconfiguration message to the DU via F1 message (e.g. UE CONTEXT MODIFICATION CONFIRM message). The RRC message includes the candidate cell configuration, and may also include the triggering events/execution conditions associated with the candidate cell(s) (e.g for UE triggered mobility). The F1 message may also include the configured candidate cell list, and/or the triggering events/conditions (e.g for DU triggered mobility). In block 1210, the DU forwards the received RRCReconfiguration message to the UE. In block 1212, the UE responds to the DU with an RRCReconfigurationComplete message, for which the DU forwards to the CU in block 1214 (e.g. via an UL RRC MESSAGE TRANSFER message).

In some embodiments, after block 1206, the CU may send an UE CONTEXT MODIFICATION REQUEST message to the source DU to inform the configured/accepted candidate cell list. The message may also include the CU generated triggering events/execution conditions (e.g for DU triggered mobility) and the source DU responses to CU with UE CONTEXT MODIFICATION RESPONSE message. This message may include the DU generated triggering events/execution conditions (e.g. for UE triggered mobility or DU triggered mobility), and then the CU sends the generated RRCReconfiguration message to the source DU via F1 message (e.g. DL RRC MESSAGE TRANSFER message).

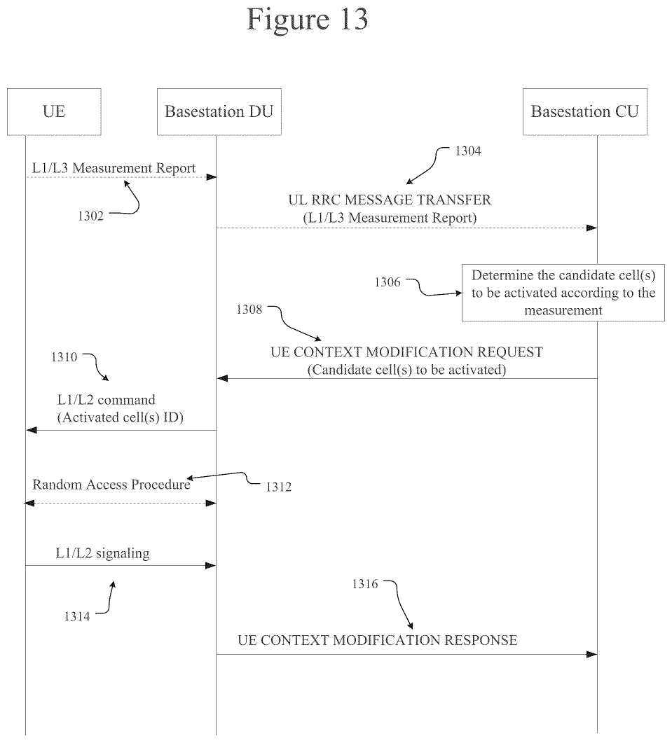

FIGS. 9-12 can be considered part of the candidate cell configuration initiation/preparation phase, while FIGS. 13-18 are part of the L1/L2 mobility triggering phase. The overall procedure of L1/L2 mobility may be any one of the combination for part of the candidate cell configuration initiation/preparation phase and part of the L1/L2 mobility triggering phase. There are several options for triggering L1/L2 mobility. As discussed above, there may be a NW triggered mobility or a UE triggered mobility. For the NW triggered mobility, it may be triggered by the CU or the DU. For CU triggered mobility, the CU sends the candidate cell(s) to be activated/switched to the DU and the DU sends L1/L2 command to indicate the candidate cell(s) to be activated/switched to the UE. For DU triggered mobility, the DU sends L1/L2 command to indicate the candidate cell(s) to be activated/switched to the UE and after completion of L1/L2 mobility (e.g. successful completion RA towards the DU, or successful reception of L1/L2 signaling at the DU from the UE), the DU may inform the activated/target cell to the CU. In one embodiment, the DU only informs the activated/target SpCell, but not the activated/target SCells to the CU. If the candidate cells are all activated as SCells (i.e. the L1/L2 mobility is triggered for SCell addition/change), then the DU may not inform the CU. In another embodiment, the DU informs all activated candidate cell(s), including both SpCell and SCell(s).

For UE triggered mobility, the UE directly triggers L1/L2 mobility when at least one of the execution conditions is met. After completion of L1/L2 mobility (e.g. successful completion RA towards the DU, or successful reception of L1/L2 signaling at the DU from the UE), the DU may inform the activated/target cell to the CU. In one embodiment, the DU only informs the activated/target SpCell, but not the activated/target SCells to the CU. If the candidate cells are all activated as SCells (i.e. the L1/L2 mobility is triggered for SCell addition/change), then the DU shall not inform the CU. In another embodiment, the DU informs all activated candidate cell(s), including both SpCell and SCell(s).

FIG. 13 shows an embodiment of intra-DU mobility based on CU triggering determination. FIG. 13 is applicable to Embodiment 1 and Embodiment 4 from Table 5. FIG. 4 illustrated intra-DU mobility while FIG. 13 shows intra-DU mobility based on CU triggering determination. In block 1302, the L1/L3 measurement report is provided from the UE to the DU and is forwarded to the CU in block 1304. The measurement report is used to determine the candidate cell in block 1306. Blocks 1302-1306 were discussed in other embodiments.

In block 1308, after the CU determines the candidate cell(s) to be activated/switched to, e.g. according to L1 or/and L3 measurement report, or load balance, then the CU sends the candidate cell(s) to be activated/switched to the DU via F1 message (e.g. UE CONTEXT MODIFICATION REQUEST message or other message). In block 1310, the DU sends an L1/L2 command to indicate the candidate cell(s) to be activated/switched to the UE. In block 1312, the UE activates/accesses the target cell (e.g. via random access procedure), and sends L1/L2 signaling (e.g. via ACK, UCI, MAC CE) to the DU in block 1314 to complete the L1/L2 mobility procedure. In block 1316, the DU responds to the CU (e.g. via UE CONTEXT MODIFICATION RESPONSE message or other message). The message may include the activated/target cell ID(s).

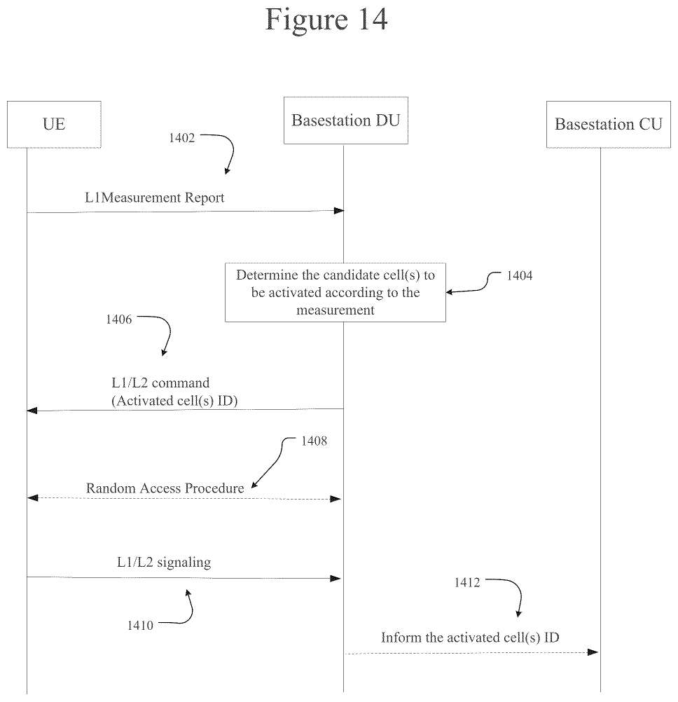

FIG. 14 shows an embodiment of intra-DU mobility based on DU triggering determination. FIG. 14 is applicable to Embodiment 2 and Embodiment 3 from Table 5. FIG. 4 illustrated intra-DU mobility while FIG. 14 shows intra-DU mobility based on DU triggering determination. In block 1402, the L1 measurement report is provided from the UE to the DU. The DU determines the candidate cell to be activated based on the measurement in block 1404. In block 1406, after the DU determines the candidate cell(s) to be activated/switched to, then the DU sends L1/L2 command to indicate the candidate cell(s) to be activated/switched to the UE. In block 1408, the UE activates/accesses the target cell (e.g. via random access procedure), and sends L1/L2 signaling in block 1410 to the DU to complete the L1/L2 mobility procedure. In block 1412, the DU may inform the activated/target cell(s) to the CU (e.g. via ACCESS SUCCESS message).

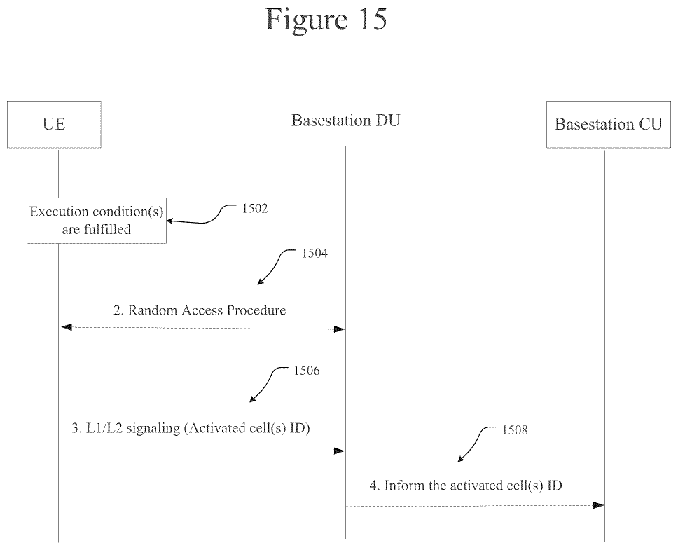

FIG. 15 shows an embodiment of intra-DU mobility based on UE triggering determination. FIG. 4 illustrated intra-DU mobility while FIG. 15 shows intra-DU mobility based on UE triggering determination. In block 1502, the UE evaluates the execution condition(s) for the candidate cell. If at least one candidate cell satisfies the corresponding execution condition(s), the UE applies/activates the corresponding candidate cell configuration. In block 1504, the UE activates/accesses the target cell (e.g. via random access procedure), and sends L1/L2 signaling (e.g. via ACK, UCI, MAC CE) to the DU in block 1506 to complete the L1/L2 mobility procedure. In block 1508, the DU informs the CU about the successful completion of L1/L2 mobility (e.g. via ACCESS SUCCESS message or other message). The message may include the activated/target cell ID(s).

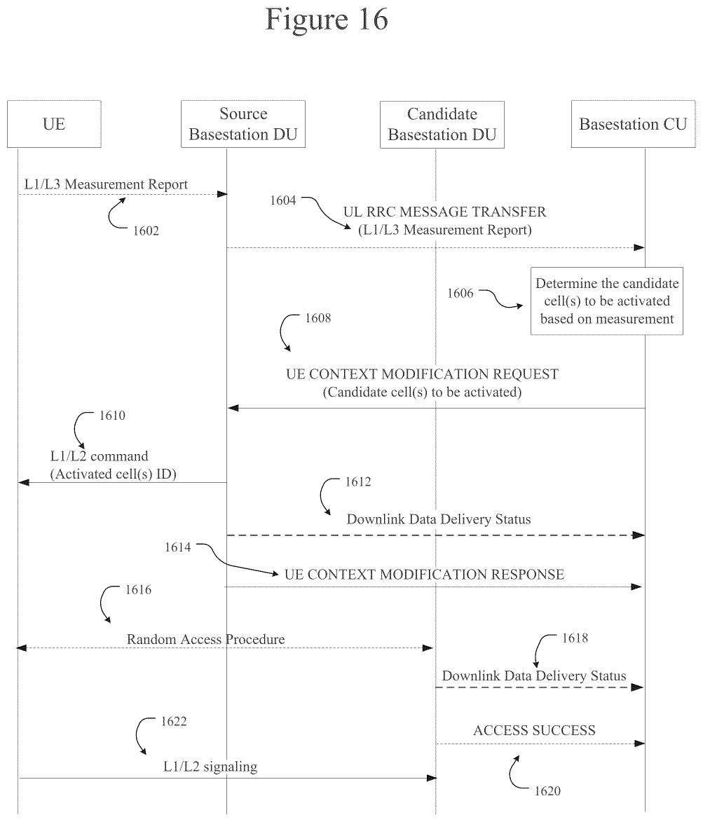

FIG. 16 shows an embodiment of inter-DU mobility based on CU triggering determination. FIG. 16 is applicable to Embodiment 1 and Embodiment 4 from Table 5. FIG. 5 illustrated inter-DU mobility while FIG. 16 shows inter-DU mobility based on CU triggering determination. In block 1602, the L1/L3 measurement report is provided from the UE to the source DU and is forwarded to the CU in block 1604. The measurement report is used to determine the candidate cell in block 1606. Blocks 1602-1606 were discussed in other embodiments. In block 1608, the CU determines the candidate cell(s) to be activated/switched to (e.g. according to L1 or/and L3 measurement report, or/and load condition), and the CU sends the candidate cell(s) to be activated/switched to the source DU via F1 message (e.g. UE CONTEXT MODIFICATION REQUEST message or other message). In block 1610, the source DU sends an L1/L2 command to indicate the candidate cell(s) to be activated/switched to the UE. The source DU may also send a Downlink Data Delivery Status frame in block 1612 to inform the CU about the unsuccessfully transmitted downlink data to the UE. In block 1614, the source DU responds to the CU (e.g. via UE CONTEXT MODIFICATION RESPONSE message or other message). In block 1616, the UE activates/accesses the target cell (e.g. via random access procedure), and sends L1/L2 signaling to the DU in block 1622 to complete the L1/L2 mobility procedure. After block 1616, the target DU may send a Downlink Data Delivery Status frame in block 1618 to inform the CU. Downlink packets may include PDCP PDUs not successfully transmitted in the source DU, are sent from the CU to the target DU. The target DU may also inform the CU about the successful completion of L1/L2 mobility in block 1620 (e.g. via an ACCESS SUCCESS message). The message may also include the activated/target cell(s).

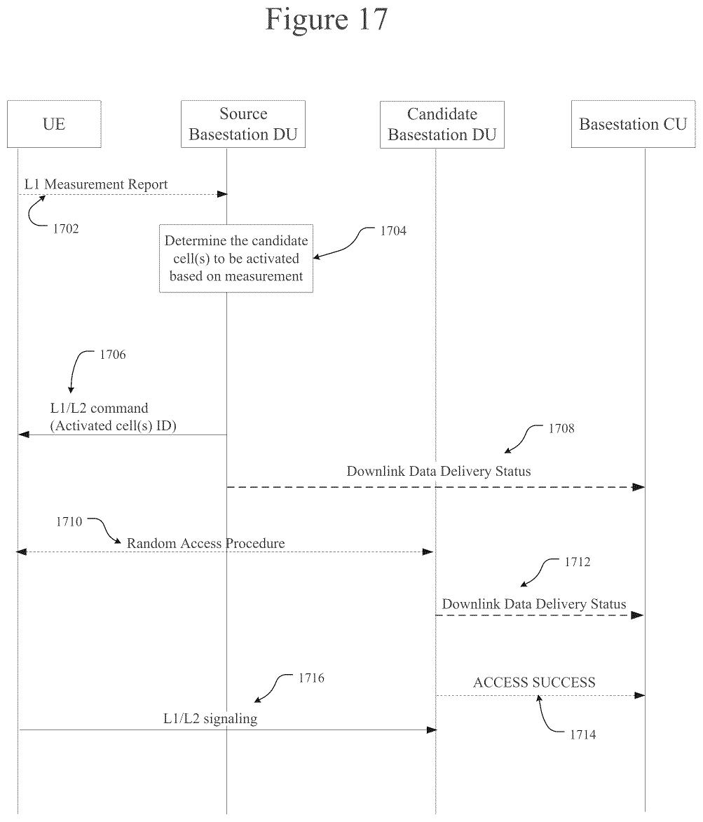

FIG. 17 shows an embodiment of inter-DU mobility based on DU triggering determination. FIG. 17 is applicable to Embodiment 2 and Embodiment 3 from Table 5. FIG. 5 illustrated inter-DU mobility while FIG. 17 shows inter-DU mobility based on DU triggering determination. In block 1702, the L1 measurement report is provided from the UE to the source DU. The source DU determines the candidate cell to be activated based on the measurement in block 1704. In block 1706, after the source DU determines the candidate cell(s) to be activated/switched to, then the source DU sends L1/L2 command to indicate the candidate cell(s) to be activated/switched to the UE. The source DU determines the candidate cell(s) to be activated/switched to (e.g. according to L1 measurement report), and the source DU sends L1/L2 command to indicate the candidate cell(s) to be activated/switched to the UE. The source DU may also send a Downlink Data Delivery Status frame in block 1708 to inform the CU about the unsuccessfully transmitted downlink data to the UE. In block 1710, the UE activates/accesses the target cell (e.g. via random access procedure), and sends L1/L2 signaling to the DU in block 1716 to complete the L1/L2 mobility procedure. After block 1710, the target DU may send a Downlink Data Delivery Status frame in block 1712 to inform the CU. Downlink packets may include PDCP PDUs not successfully transmitted in the source DU, are sent from the CU to the target DU. The target DU may also inform the CU about the successful completion of L1/L2 mobility in block 1714 (e.g. via an ACCESS SUCCESS message). The message may also include the activated/target cell(s).

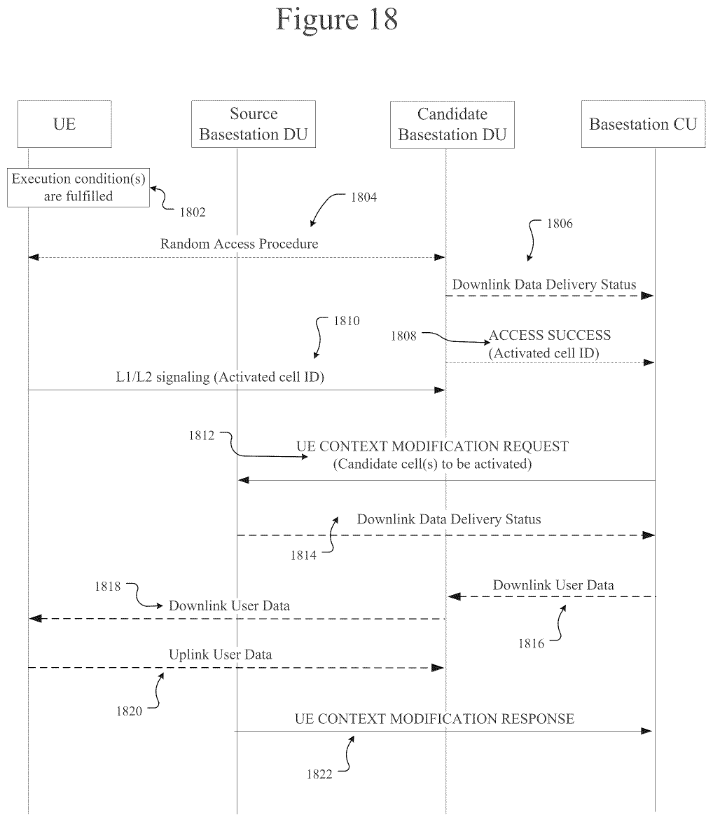

FIG. 18 shows an embodiment of inter-DU mobility based on UE triggering determination. FIG. 5 illustrated inter-DU mobility while FIG. 18 shows inter-DU mobility based on UE triggering determination. In block 1802, the UE evaluates the execution condition(s) for the candidate cell. If at least one candidate cell satisfies the corresponding execution condition(s), the UE applies/activates the corresponding candidate cell configuration. In block 1804, the UE activates/accesses the target cell (e.g. via random access procedure), and sends L1/L2 signaling to the DU in block 1810 to complete the L1/L2 mobility procedure. After block 1804, the target DU may send a Downlink Data Delivery Status frame in block 1806 to inform the CU. Downlink packets may include PDCP PDUs not successfully transmitted in the source DU, are sent from the CU to the target DU. The target DU may also inform the CU about the successful completion of L1/L2 mobility in block 1808 (e.g. via an ACCESS SUCCESS message). The message may also include the activated/target cell(s).

In block 1812, the CU may also initiate UE context modification procedure to the source DU to stop the data transmission for the UE. The CU sends a UE CONTEXT MODIFICATION REQUEST message to the source DU and indicates to stop the data transmission for the UE. The source DU also sends a Downlink Data Delivery Status frame in block 1814 to inform the CU about the unsuccessfully transmitted downlink data to the UE. The source DU responds to the CU with the UE CONTEXT MODIFICATION RESPONSE message in block 1822. In some embodiments, the downlink user data is provided by the CU to the candidate DU in block 1816, which is then provided to the UE in block 1818. The uplink user data is provided from the UE to the source DU in block 1820.

### Control of L1/L2 Mobility Triggering

The CU can control whether the DU is allowed to trigger L1/L2 mobility (i.e. sending L1/L2 mobility triggering command to the UE). If the CU determines to stop/suspend L1/L2 mobility triggering (e.g. when the CU determines to trigger L3 mobility, via legacy HO (i.e. PCell change), DAPS HO, legacy PSCell addition/change, etc.), then the CU sends an indication (e.g. “L/L2 mobility triggering indicator”, the indicator is set as “stop/suspend”) to indicate the DU to stop/suspend L1/L2 mobility triggering via F1 message (e.g. UE CONTEXT MODIFICATION REQUEST message or other message). Upon/after reception of that indication, the DU shall not send L1/L2 mobility triggering command to the UE. If the CU determines to resume/restart L1/L2 mobility triggering (e.g. when completion of L3 mobility), then the CU sends an indication (e.g. “L/L2 mobility triggering indicator”, the indicator is set as “restart/resume”) to indicate the DU resume/restart L1/L2 mobility triggering via F1 message (e.g. UE CONTEXT MODIFICATION REQUEST message or other message). Upon/after reception of that indication, the DU can restart to send L1/L2 mobility triggering command to the UE, e.g. when determines the triggering event(s) is met.

The DU can request to restart/resume L1/L2 mobility triggering, e.g. when determination the triggering event(s) is met. The DU sends an indication (e.g. “L/L2 mobility triggering request indicator”) to request the CU to allow restarting the L1/L2 mobility triggering via F1 message (e.g. UE CONTEXT MODIFICATION REQUIRED message or other message). The CU determines whether to accept the request, and sends the response to the DU via F1 message (e.g. UE CONTEXT MODIFICATION CONFIRM or UE CONTEXT MODIFICATION REFUSE message). If the CU rejects the request, it may also include the cause (e.g. L3 mobility triggered) in the response message.

### Mobility Interactions

In alternative embodiments, the L1/L2 mobility may interact with other functions such as handover (HO), conditional handover (CHO), conditional PSCell addition/change (CPAC), dual active protocol stack (DAPS), or other functions. In one embodiment, L1/L2 mobility configuration may include those other functions. L1/L2 mobility may be combined with CHO/CPAC (i.e. UE triggered L1/L2 mobility), where the UE automatically triggers L1/L2 mobility based on the pre-configured execution conditions and stored candidate cell configuration. In another example, L1/L2 mobility may be combined with DAPS, such that the UE maintains the source cell connection when triggering L1/L2 mobility to the target candidate cell.

In alternative embodiments, those other functions may be modified to include L1/L2 mobility configuration. For example, legacy HO, legacy PSCell addition/change, CHO, CPAC, DAPS, or HO configuration may be modified to include the candidate cell configuration for L1/L2 mobility. In other words, L1/L2 mobility configuration is based on the target cell configuration, and L1/L2 mobility can be performed (if triggered) after completion of other functions. Alternatively, the L1/L2 mobility and other functions may be configured to the UE independently.

When L1/L2 mobility has been configured (i.e. the UE has stored candidate cells configuration), then the source cell/node may want to initiate or prepare the L3 PCell change (e.g. legacy HO, CHO, DAPS, etc.) and/or L3 PSCell addition/change (e.g. legacy PSCell addition/change, CPAC, etc.). The source cell/node may send information to the target cell/node to transfer/maintain/remove the candidate cell configuration. In one embodiment, the information may include the candidate cell(s) configuration, such as the candidate cell ID and each cell configuration. In some embodiments, there may be a list of candidate cells which shall be maintained/removed. In another embodiment, the information may include an indication of whether to maintain/remove the candidate cell(s) configuration in the other functions' configuration. For example, the indication may indicate whether to maintain/remove the candidate PCell configuration, the candidate PSCell configuration, the candidate SpCell configuration and/or the candidate SCell configuration (e.g. “maintainCandidatePCell”, “maintainCandidatePSCell”, “maintainCandidateSpCell”, “maintainCandidateSCell”). In another embodiment, the information may include an indication as to which candidate cell's configuration may be considered as the baseline/reference for delta configuration of the target cell configuration in other functions' configuration (e.g. the indication indicates one or more candidate cell IDs as the baseline cell(s)). For example, the indication may indicate which candidate cell's configuration can be considered as the baseline/reference for delta configuration of the target PCell, target PSCell, target SpCell or/and target SCell (e.g. “baselineForPCell”, “baselineForPSCell”, “baselineForSpCell”, “baselineForSCell”). The other functions' may have different configurations (e.g. legacy HO/legacy PSCell addition/change/CHO/CPAC/DAPS HO configuration).

In the embodiments where information is provided, the information above can be transferred to the target cell/node including the information directly in an Xn/X2 message (e.g. HO request message, SN addition request message, or SN change required message). In another embodiment, the information may be provided in a RRC message (e.g. HandoverPreparationInformation, CG-Config, or CG-ConfigInfo message). The RRC message may be included as one information element in a Xn/X2 message.

If other functions are triggered or executed first, then there may be alternatives for the handling on stored L1/L2 mobility configuration. In one embodiment, the UE may remove the stored L1/L2 mobility configuration (e.g. candidate cell configuration). For example, the UE may remove the stored L1/L2 mobility configuration according to an explicit indication from the source cell, where the source cell explicitly releases the candidate cell configuration via RRC message (e.g. RRC reconfiguration message) before sending a HO/PSCell addition/change command to the UE. In an alternative embodiment, the UE may remove the stored L1/L2 mobility configuration according to the explicit indication from the target cell. For example, the target cell explicitly releases the candidate cell configuration in other functions' command (e.g. including an indication to indicate the remove of stored candidate cell configuration in RRC reconfiguration message). In another example, the target cell may explicitly indicate which candidate cells configuration shall be released in other functions' command (e.g. include a list of released candidate cell in RRC reconfiguration message). In another example, the UE autonomously removes the stored L1/L2 mobility configuration upon triggering the execution of other functions, such as upon receiving the L3 mobility command (e.g. RRC reconfiguration message for HO or/and PSCell addition/change) or triggering the execution of conditional L3 mobility (e.g. the execution condition for CHO/CPAC is met). In another example, the UE autonomously removes the stored L1/L2 mobility configuration upon completing the execution of other functions, such as upon completion of RA to the target cell.

In another embodiment for where other functions are triggered or executed first, then the L1/L2 mobility configuration may be maintained by the UE through the stored L1/L2 mobility configuration. For example, the UE maintains the stored L1/L2 mobility configuration according to the explicit indication from the target cell. The explicit indication may be from the target cell, which explicitly indicates to maintain of candidate cell configuration in other functions' command (e.g. include an indication to indicate the maintain of stored candidate cell configuration in RRC reconfiguration message). In another example, the target cell explicitly indicates which candidate cells configuration shall be maintained in other functions' command (e.g. include a list of released/maintained candidate cell in RRC reconfiguration message).

In another embodiment, the UE may maintain the stored L1/L2 mobility configuration without explicit indication. If L1/L2 mobility configuration is maintained other functions may be triggered/executed first as described above. The handling of execution condition evaluation (i.e. for UE triggered L1/L2 mobility) may be handled upon triggering the execution of other functions. For example the UE automatically stops the evaluation of execution conditions (e.g. for all candidate cells, only for L1/L2 mobility candidate cells within MCG, or only for L1/L2 mobility candidate cells within SCG). Alternatively, the UE may stop the evaluation of execution conditions according to an explicit indication from the network (e.g. target cell), which may explicitly indicate to stop of execution conditions evaluation for candidate cells (e.g. for all candidate cells, only for L1/L2 mobility candidate cells within MCG, or only for L1/L2 mobility candidate cells within SCG) in an RRC message (e.g. RRC reconfiguration message) or MAC CE.

When the UE successfully completes other function's execution (e.g. completion of RA to the target cell), then the UE may remove the stored L1/L2 mobility configuration. Alternatively, the UE may restart the evaluation of execution conditions for UE triggered L1/L2 mobility (e.g. for all candidate cells, only for L1/L2 mobility candidate cells within MCG, or only for L1/L2 mobility candidate cells within SCG).

In some embodiments, the removal of stored L1/L2 mobility configuration may depend on which type of function is performed. For example, if the function is related to MCG (e.g. HO/CHO/DAPS), the UE may remove only L1/L2 mobility configuration within MCG, only L1/L2 mobility configuration within SCG, or L1/L2 mobility configuration within both MCG and SCG (i.e. all candidate cell configuration). In another example, if the function is related to SCG (e.g. PSCell addition/change/CPACS), the UE may remove only L1/L2 mobility configuration within MCG, only L1/L2 mobility configuration within SCG, or L1/L2 mobility configuration within both MCG and SCG (i.e. all candidate cell configuration).

The embodiments described above relate to the L1/L2 mobility being triggered first. In alternative embodiments, the other functions may be triggered or executed first. When the other functions are triggered first, there may be different alternatives, such as when CHO/CPAC and L1/L2 mobility are configured for the UE independently (e.g. the UE stored both CHO/CPAC candidate cell configuration and L1/L2 mobility candidate cell configuration) or when the UE triggers L1/L2 mobility (e.g. receiving NW triggered L1/L2 command or triggering the execution of UE triggered L1/L2 mobility). The alternatives include whether the UE removes the stored CHO/CPAC configuration or whether the UE maintains the stored CHO/CPAC configuration, but stops the evaluation of CHO/CPAC. When the UE successfully completes L1/L2 mobility (e.g. completion of RA to the target cell or sending L1/L2 signaling to the target cell), then the UE may remove the stored CHO/CPAC configuration. Alternatively, the UE may restart the evaluation of CHO/CPAC. In some embodiments, the remove of stored CHO/CPAC configuration may depend on which type of L1/L2 mobility is performed. For example, if L1/L2 mobility is for a cell change within MCG (e.g. PCell change, MCG SCell addition/change), the UE may remove only CHO configuration, only CPAC configuration, or both CHO and CPAC configuration. In another example, if L1/L2 mobility is for a cell change within SCG (e.g. PSCell addition/change, SCG SCell addition/change), the UE may remove only CPAC configuration, or both CHO and CPAC configuration.

The embodiments described above relate to the L1/L2 mobility being triggered first, or the other functions being triggered first. However, there is also an embodiment, when the handling of the other functions and the L1/L2 mobility are triggered simultaneously or substantially simultaneous. When the triggering conditions for CHO/CPAC and L1/L2 mobility are met simultaneously (e.g. the UE detects the CHO/CPAC execution conditions are met, and the L1/L2 mobility execution conditions are met or receives L1/L2 mobility command from the NW), then the UE may first execute one function according to the following alternatives with regard to priority:
CHO>L1/L2 mobility for PCell change>CPAC>L1/L2 mobility for PSCell change>L1/L2 mobility for SCell change
L1/L2 mobility for PCell change>CHO>L1/L2 mobility for PSCell change>CPAC>L1/L2 mobility for SCell change

### Failure Handling for Mobility Interaction

If conditional L3 mobility (e.g. CHO, CPAC) and L1/L2 mobility are configured simultaneously, upon detection of a L1/L2 mobility failure, the UE may continue conditional L3 mobility evaluation and selects one conditional L3 mobility candidate cell to execute the conditional L3 mobility when the execution condition (e.g. the conditional L3 mobility execution condition or an additional pre-configured threshold for failure recovery) is met. In one embodiment, upon detection of L1/L2 mobility for PCell change failure, the UE continues CHO evaluation and selects one CHO candidate cell to execute the CHO when the execution condition (e.g. the CHO execution condition or an additional pre-configured threshold for failure recovery) is met. In one embodiment, upon detection of L1/L2 mobility for PSCell change failure, the UE continues CPAC evaluation and selects one CPAC candidate cell to execute the CPAC when the execution condition (e.g. the CPAC execution condition or an additional pre-configured threshold for failure recovery) is met.

### Measurement Handling for Conditional Mobility

In the conditional mobility (e.g. CHO, CPAC, UE triggered L1/L2 mobility), the NW (e.g. the MN, the SN) may generate/configure a separate measurement gap for the UE and send it to the UE via RRC signaling (e.g. RRCReconfiguration message with conditional mobility configuration). For example, introducing a conditional reconfiguration related measurement gap (e.g. conditionalReconfigurationGap) within the existing conditionalReconfiguration IE. The conditional reconfiguration related measurement gap is only used by the UE during the evaluation of conditional mobility. During the conditional mobility preparation, the source node (e.g. the source SN, the source MN) may send the original/source measurement gap configuration to the target node (e.g. the target SN, the target MN). The target node generates the measurement gap for the candidate cell (i.e. the measurement gap configuration included in the candidate cell configuration), based on the original/source measurement gap configuration.

When the UE receives the conditional reconfiguration related measurement gap, the UE may ignore the original/source measurement gap, but stores two sets of measurement gap configuration (i.e. the original measurement gap configuration and the conditional reconfiguration related measurement gap). Upon triggering the execution of conditional mobility, the UE applies the measurement gap configuration for the candidate cell based on the original/source measurement gap configuration. Upon the successful completion of conditional mobility or triggering the execution of conditional mobility, the UE may then remove the conditional reconfiguration related measurement gap.

### Mobility Interaction in Idle/Inactive State

There are several alternative embodiments for handling of L1/L2 mobility configuration (e.g. candidate cell configuration) when UE enters RRC_INACTIVE/IDLE state. In a first embodiment, the NW explicitly indicates whether to store/maintain/keep or remove the candidate cell configuration when the UE enters RRC_INACTIVE/IDLE state via RRC signaling (e.g. include an indicator in RRCRelease message). The UE stores/maintains/keeps or removes the stored candidate cell configuration upon entering RRC_INACTIVE/IDLE state, based on the explicit indication. In a second embodiment, the NW explicitly indicates which candidate cell configuration can be stored/maintained/kept or removed when UE enters RRC_INACTIVE/IDLE state via RRC signaling (e.g. include a list of maintained cell ID or a list of removed cell ID in RRCRelease message). The UE stores/maintains/keeps or removes the indicated candidate cell configuration upon entering RRC_INACTIVE/IDLE state, based on the explicit indication. In a third embodiment, the UE autonomously removes the stored candidate cell configuration upon entering RRC_INACTIVE/IDLE state (e.g. when receiving the RRCRelease message with/without including suspendConfig). In a fourth embodiment, the UE maintains the stored candidate cell configuration upon entering RRC_INACTIVE/IDLE state.

If the L1/L2 mobility configuration is maintained during RRC_INACTIVE state, upon RRC connection resume (e.g. transition form RRC_INACTIVE state to RRC_CONNECTED state) there are several alternative embodiments for handling of the stored configuration. In a first embodiment, the NW explicitly indicates the UE to resume/activate one or more candidate cells via RRC signaling (e.g. include one or more candidate cell IDs to be resumed/activated in RRCResume message). The UE resumes/actives the indicated candidate cell(s) upon reception of the RRC signaling, based on the explicit indication. In a second embodiment, the NW explicitly indicates that the UE restore one or more candidate cell configuration, which may be as a baseline for the subsequent delta configuration for adding/modifying the serving cell (e.g. include one or more candidate cell IDs to be restored in RRCResume message), and may also include the delta configuration based on the indicated cell configuration via RRC signaling. The UE restores the indicated candidate cell(s) configuration upon reception of the RRC signaling, based on the explicit indication. The UE may apply the received delta configuration based on the indicated cell configuration, if any.

### Multi-Connectivity

L1/L2 based inter-cell mobility mechanism may also be used in multi-connectivity architecture (i.e. multiple cell group configuration can be pre-configured by the NW). The multi-connectivity may be referred to as Multi-Radio Dual Connectivity (MR-DC). The embodiments discussed throughout may be applied to any multi-connectivity/MR-DC environment or architecture, in which a “candidate cell” may be referred to as a “candidate cell group” (e.g. MCG, SCG) for multi-connectivity/MR-DC. The dynamic cell group activation/switch may be triggered by the NW via RRC signaling (e.g. RRC reconfiguration message) or L1/L2 command (e.g. DCI, MAC CE). The UE may also trigger the cell group activation/switch based on the pre-configured execution conditions and candidate cell group configuration. Applying the embodiments to multi-connectivity/MR-DC may include a selective activation/switch, in which a “candidate cell” may be referred to as a “candidate cell group” (e.g. MCG, SCG) for multi-connectivity/MR-DC.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

1. A method for wireless communication comprising:
receiving, by user equipment (UE) from a base station, a configuration message that includes a list of candidate cells each with a configuration and a candidate cell configuration index corresponding to the configuration;
sending, to the base station, a measurement report that comprises a Layer 1 (“L1”) measurement for at least one of the list of candidate cells;
receiving, from the base station, a medium access control (MAC) control element (CE) command comprising the candidate cell configuration index of a target cell of the list of candidate cells, and a transmission configuration indicator (TCI) state of the target cell; and
sending a communication to the target cell based on the MAC CE command and the configuration of the target cell.

2-3. (canceled)

4. The method of claim 1, wherein the MAC CE command further comprises at least one of a timing advance (TA) value or a Synchronization Signal Block (SSB) identification (ID) related to the target cell.

5. The method of claim 1, wherein the configuration message comprises at least one of a physical cell identity (“PCI”), reference signal (“RS”) ID related to a candidate cell, or a transmission configuration indicator (“TCI”) state ID related to the candidate cell.

6-10. (canceled)

11. The method of claim 1, further comprising at least one of:
applying a stored cell configuration of the target cell; or
performing a mobility from a current serving cell to the target cell; or
starting a timer for the mobility upon triggering Layer 1 (L1)/L2-based inter-cell mobility, wherein the timer is a radio resource control (“RRC”) layer timer T304.

12. (canceled)

13. The method of claim 11, wherein the timer is stopped when a L1/L2-based inter-cell mobility is informed as successful completion.

14. The method of claim 11, further comprising at least one of:
determining a failure for the mobility, based on expiration of the timer; or
selecting another cell among the candidate cells to perform the mobility to the selected another cell.

15-16. (canceled)

17. The method of claim 1, further comprising:
removing a stored candidate cell configuration upon entering an IDLE state or upon receiving a RRC release message including an indication of a suspension of a RRC connection.

18-21. (canceled)

22. A method for wireless communication comprising:
sending, by a base station to user equipment (UE), a configuration message that includes a list of candidate cells each with a configuration and a candidate cell configuration index corresponding to the configuration;
receiving, from the UE, a measurement report that comprises a Layer 1 (“L1”) measurement for at least one of the list of candidate cells;
sending, to the UE, a medium access control (MAC) control element (CE) command comprising the candidate cell configuration index of a target cell of the list of candidate cells, and a transmission configuration indicator (TCI) state of the target cell; and
receiving a communication at the target cell, based on the MAC CE command and the configuration of the target cell.

23-24. (canceled)

25. The method of claim 22, wherein the MAC CE command further comprises at least one of a timing advance (TA) value or a Synchronization Signal Block (SSB) identification (ID) related to the target cell.

26. The method of claim 22, wherein the configuration message comprises at least one of a physical cell identity (“PCI”), reference signal (“RS”) ID related to a candidate cell, or a transmission configuration indicator (“TCI”) state ID related to the candidate cell.

27-34. (canceled)

35. A first wireless communications apparatus comprising a processor and a memory, wherein the processor is configured to read code from the memory and implement:
receiving, from a base station, a configuration message that includes a list of candidate cells each with a configuration and a candidate cell configuration index corresponding to the configuration;
sending, to the base station, a measurement report that comprises a Layer 1 (“L1”) measurement for at least one of the list of candidate cells;
receiving, from the base station, a medium access control (MAC) control element (CE) command comprising the candidate cell configuration index of a target cell of the list of candidate cells, and a transmission configuration indicator (TCI) state of the target cell; and
sending a communication to the target cell based on the MAC CE command and the configuration of the target cell.

36. (canceled)

37. The first wireless communication apparatus of claim 35, wherein the MAC CE command further comprises at least one of a timing advance (TA) value or a Synchronization Signal Block (SSB) identification (ID) related to the target cell.

38. The first wireless communication apparatus of claim 35, wherein the configuration message comprises at least one of a physical cell identity (“PCI”), reference signal (“RS”) ID related to a candidate cell, or a transmission configuration indicator (“TCI”) state ID related to the candidate cell.

39. The first wireless communication apparatus of claim 35, further comprising at least one of:
applying a stored cell configuration of the target cell; or
performing a mobility from a current serving cell to the target cell; or
starting a timer for the mobility upon triggering a Layer 1 (L1)/L2-based inter-cell mobility, wherein the timer is a radio resource control (“RRC”) layer timer T304.

40. The first wireless communication apparatus of claim 39, wherein the timer is stopped when a L1/L2-based inter-cell mobility is informed as successful completion.

41. The first wireless communication apparatus of claim 39, further comprising at least one of:
determining a failure for the mobility, based on expiration of the timer; or
selecting another cell among the candidate cells to perform the mobility to the selected another cell.

42. The first wireless communication apparatus of claim 35, further comprising:
removing a stored candidate cell configuration upon entering an IDLE state or upon receiving a RRC release message including an indication of a suspension of a RRC connection.

43. A second wireless communications apparatus comprising a processor and a memory, wherein the processor is configured to read code from the memory and implement the method according to claim 22.

44. The second wireless communications apparatus of claim 43, wherein the processor is further configured to read code from the memory and implement the method according to claim 25.

45. The second wireless communications apparatus of claim 43, wherein the processor is further configured to read code from the memory and implement the method according to claim 26.
